(19) United States
(12) Patent Application Publication
(10) Pub. No.: US 2026/0019642 A1
(43) Pub. Date: Jan. 15, 2026

(54) INDICATIONS OF PROCESSING ORDERS OF POST-PROCESSING FILTERS

(71) Applicant: Bytedance Inc., Los Angeles, CA (US)

(72) Inventors: Ye-Kui Wang, San Diego, CA (US); Jizheng Xu, San Diego, CA (US); Li Zhang, San Diego, CA (US)

(21) Appl. No.: 19/327,712

(22) Filed: Sep. 12, 2025

Related U.S. Application Data
(63) Continuation of application No. PCT/US2024/019837, filed on Mar. 14, 2024.
(60) Provisional application No. 63/490,116, filed on Mar. 14, 2023.
(60) Provisional application No. 63/495,907, filed on Apr. 13, 2023.

(51) Int. Cl. H04N 19/70; H04N 19/117; H04N 19/184; H04N 19/80

(52) U.S. Cl. CPC H04N 19/70; H04N 19/117; H04N 19/184; H04N 19/80

(57) ABSTRACT

A mechanism for processing video data is disclosed. The mechanism includes determining to signal a processing order or a preferred processing order of different post-processing filters, including zero or more neural-network post-filters (NNPFs) and zero or more non-NNPF post-processing filters, in a supplemental enhancement information (SEI) processing order SEI message. A conversion is performed between a visual media data and a bitstream based on the SEI processing order SEI message.

### CROSS-REFERENCE TO RELATED APPLICATIONS

This is a continuation of International Patent Application No. PCT/US2024/019837, filed on Mar. 14, 2024, which claims the priority to and benefits of U.S. Provisional Application No. 63/490,116, filed on Mar. 14, 2023, and U.S. Provisional Application No. 63/495,907, filed on Apr. 13, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to signal a processing order or a preferred processing order of different post-processing filters, including zero or more neural-network post-filters (NNPFs) and zero or more non-NNPF post-processing filters, in a supplemental enhancement information (SEI) processing order SEI message; and performing a conversion between a visual media data and a bitstream based on the SEI processing order SEI message.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining to signal a processing order or a preferred processing order of different post-processing filters, including zero or more neural-network post-filters (NNPFs) and zero or more non-NNPF post-processing filters, in a supplemental enhancement information (SEI) processing order SEI message; and generating a bitstream based on the determining.

A fifth aspect relates to a method for storing bitstream of a video comprising: determining to signal a processing order or a preferred processing order of different post-processing filters, including zero or more neural-network post-filters (NNPFs) and zero or more non-NNPF post-processing filters, in a supplemental enhancement information (SEI) processing order SEI message; generating a bitstream based on the determining; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of deriving luma channels from a luma component.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of embodiments, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed embodiments. As such, the embodiments described herein are applicable to other video codec protocols and designs also. In the present disclosure, editing changes are shown to text by triple brackets indicating cancelled text (i.e., [a]]] indicates that ‘a’ is deleted) and double braces indicating added text (i.e., {{a}} indicates that ‘a’ is added), with respect to the Versatile Video Coding (VVC) specification.

### 1. INITIAL DISCUSSION

This disclosure is related to image/video coding technologies. Specifically, this disclosure is related to signalling and specifying processing orders for post-processing filters, including neural-network post-processing filters (NNPFs). The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. ABBREVIATIONS

The following abbreviations may be used throughout this disclosure: adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), neural-network post-processing filter (NNPF), neural-network post-filter activation (NNPFA), neural-network post-filter characteristics (NNPFC), picture parameter set (PPS), picture unit (PU), random access skipped leading (RASL) picture, supplemental enhancement information (SEI), step-wise temporal sublayer access (STSA), uniform resource identifier (URI), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC)

### 3. FURTHER DISCUSSION

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting a 50% bitrate reduction as compared to HEVC.

The Versatile Video Coding (VVC) standard (ITU-T H.266|ISO/IEC 23090-3) [3] and the associated Versatile Supplemental Enhancement Information for coded video bitstreams (VSEI) standard (ITU-T H.274|ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Signalling of Neural-Network Post-Processing Filters

JVET-AC2032 [5] includes the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | Descriptor |
|---|---|
| nn_post_filter_characteristics( payloadSize ) { | |
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_property_present_flag | u(1) |
| if( nnpfc_property_present_flag ) { | |
| nnpfc_base_flag | u(1) |
| /* input and output formatting */ | |
| nnpfc_num_input_pics_minus1 | ue(v) |
| if( ( nnpfc_purpose & 0x02 ) != 0 ) | |
| nnpfc_out_sub_c_flag | u(1) |
| if( ( nnpfc_purpose & 0x20 ) != 0 ) | |
| nnpfc_out_colour_format_idc | u(2) |
| if( ( nnpfc_purpose & 0x04 ) != 0 ) { | |
| nnpfc_pic_width_in_luma_samples | ue(v) |
| nnpfc_pic_height_in_luma_samples | ue(v) |
| } | |
| if( ( nnpfc_purpose & 0x08 ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| nnpfc_component_last_flag | u(1) |
| nnpfc_inp_format_idc | ue(v) |
| if( nnpfc_inp_format_idc = = 1 ) { | |
| nnpfc_inp_tensor_luma_bitdepth_minus8 | ue(v) |
| nnpfc_inp_tensor_chroma_bitdepth_minus8 | ue(v) |
| } | |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_idc | ue(v) |
| if( nnpfc_out_format_idc = = 1 ) { | |
| nnpfc_out_tensor_luma_bitdepth_minus8 | ue(v) |
| nnpfc_out_tensor_chroma_bitdepth_minus8 | ue(v) |
| } | |
| nnpfc_out_order_idc | ue(v) |
| nnpfc_overlap | ue(v) |
| nnpfc_constant_patch_size_flag | u(1) |
| if( nnpfc_constant_patch_size_flag ) { | |
| nnpfc_patch_width_minus1 | ue(v) |
| nnpfc_patch_height_minus1 | ue(v) |
| } else { | |
| nnpfc_extended_patch_width_cd_delta_minus1 | ue(v) |
| nnpfc_extended_patch_height_cd_delta_minus1 | ue(v) |
| } | |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| } | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepth_{Y} for the luma sample array of the input pictures.
Bit depth BitDepth_{C} for the chroma sample arrays, if any, of the input pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

Input picture with index 0 corresponds to the picture for which the NNPF defined by this NNPFC SEI message is activated by an NNPFA SEI message. Input picture with index i in the range of 1 to numInputPics−1, inclusive, precedes the input picture with index i−1 in output order.

When nnpfc_purpose & 0x08 is not equal to 0 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

The variables SubWidthC and SubHeightC are derived from ChromaFormatIdc as specified by Table 2.

TABLE 2
SubWidthC and SubHeightC values
derived from ChromaFormatIdc

| | Chroma | | |
|---|---|---|---|
| ChromaFormatIdc | format | SubWidthC | SubHeightC |
| 0 | Monochrome | 1 | 1 |
| 1 | 4:2:0 | 2 | 2 |
| 2 | 4:2:2 | 2 | 1 |
| 3 | 4:4:4 | 1 | 1 |

NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_purpose indicates the purpose of the NNPF as specified in Table 20.

The value of nnpfc_purpose shall be in the range of 0 to 63, inclusive, in bitstreams conforming to this edition of this document. Values of 64 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65 535, inclusive.

TABLE 20
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma |
| ( nnpfc_purpose & | format to the 4:2:2 or 4:4:4 chroma format, |
| 0x02 ) = = 0 | or from the 4:2:2 chroma format to the |
| | 4:4:4 chroma format) |
| ( nnpfc_purpose & | With chroma upsampling |
| 0x02 ) != 0 | |
| nnpfc_purpose > 0 && | No resolution upsampling (increasing |
| ( nnpfc_purpose & | the width or height) |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma |
| ( nnpfc_purpose & | bit depth or the chroma bit depth) |
| 0x10 ) = = 0 | |
| ( nnpfc_purpose & | With bit depth upsampling |
| 0x10 ) != 0 | |
| nnpfc_purpose > 0 && | No colorization (from the 4:0:0 chroma format |
| ( nnpfc_purpose & | to the 4:2:0, 4:2:2, or 4:4:4 chroma format) |
| 0x20 ) = = 0 | |
| ( nnpfc_purpose & | With colorization |
| 0x20 ) != 0 | |

NOTE 2—When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

nnpfc_id contains an identifying number that may be used to identify an NNPF. The value of nnpfc_id shall be in the range of 0 to 232-2, inclusive. Values of nnpfc_id from 256 to 511, inclusive, and from 231 to 232−2, inclusive, are reserved for future use by ITU-T|ISO/IEC. Decoders conforming to this edition of this document encountering an NNPFC SEI message with nnpfc_id in the range of 256 to 511, inclusive, or in the range of 231 to 232−2, inclusive, shall ignore the SEI message.

When an NNPFC SEI message is the first NNPFC SEI message, in decoding order, that has a particular nnpfc_id value within the current CLVS, the following applies:
This SEI message specifies a base NNPF.
This SEI message pertains to the current decoded picture and all subsequent decoded pictures of the current layer, in output order, until the end of the current CLVS.

nnpfc_mode_idc equal to 0 indicates that this SEI message contains an ISO/IEC 15938-17 bitstream that specifies a base NNPF or is an update relative to the base NNPF with the same nnpfc_id value.

When an NNPFC SEI message is the first NNPFC SEI message, in decoding order, that has a particular nnpfc_id value within the current CLVS, nnpfc_mode_idc equal to 1 specifies that the base NNPF associated with the nnpfc_id value is a neural network identified by the URI indicated by nnpfc_uri with the format identified by the tag URI nnpfc_tag_uri.

When an NNPFC SEI message is neither the first NNPFC SEI message, in decoding order, nor a repetition of the first NNPFC SEI message, in decoding order, that has a particular nnpfc_id value within the current CLVS, nnpfc_mode_idc equal to 1 specifies that an update relative to the base NNPF with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the NNPF PostProcessingFilter( ) is assigned to be the same as the base NNPF.

When this SEI message is neither the first NNPFC SEI message, in decoding order, nor a repetition of the first NNPFC SEI message, in decoding order, that has a particular nnpfc_id value within the current CLVS, an NNPF PostProcessingFilter( ) is obtained by applying the update defined by this SEI message to the base NNPF.

Updates are not cumulative but rather each update is applied on the base NNPF, which is the NNPF specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base NNPF or an update relative to the base NNPF with the same nnpfc_id value specified by nnpfc_uri.

NOTE 3—nnpfc_tag_uri enables uniquely identifying the format of neural network data specified by nnrpf_uri without needing a central registration authority.

nnpfc_tag_uri equal to “tag: iso.org,2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base NNPF or an update relative to the base NNPF with the same nnpfc_id value.

nnpfc_property_present_flag equal to 1 specifies that syntax elements related to the filter purpose, input formatting, output formatting, and complexity are present. nnpfc_property_present_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_property_present_flag shall be equal to 1.

When nnpfc_property_present_flag is equal to 0, the values of all syntax elements that may be present only when nnpfc_property_present_flag is equal to 1 and for which inference values for each of them is not specified are inferred to be equal to their corresponding syntax elements, respectively, in the NNPFC SEI message that contains the base NNPF for which this SEI provides an update.

nnpfc_base_flag equal to 1 specifies that the SEI message specifies the base NNPF. nnpf_base_flag equal to 0 specifies that the SEI message specifies an update relative to the base NNPF. When not present, the value of nnpfc_base_flag is inferred to be equal to 0.

The following constraints apply to the value of nnpfc_base_flag:
When an NNPFC SEI message is the first NNPFC SEI message, in decoding order, that has a particular nnpfc_id value within the current CLVS, the value of nnpfc_base_flag shall be equal to 1.
When an NNPFC SEI message nnpfcB is not the first NNPFC SEI message, in decoding order, that has a particular nnpfc_id value within the current CLVS and the value nnpfc_base_flag is equal to 1, the NNPFC SEI message shall be a repetition of the first NNPFC SEI message nnpfcA with the same nnpfc_id, in decoding order, i.e., the payload content of nnpfcB shall be the same as that of nnpfcA.

When an NNPFC SEI message is not the first NNPFC SEI message, in decoding order, that has a particular nnpfc_id value within the current CLVS and not a repetition of the first NNPFC SEI message with that particular nnpfc_id, the following applies:
This SEI message defines an update relative to the preceding base NNPF in decoding order with the same nnpfc_id value.
This SEI message pertains to the current decoded picture and all subsequent decoded pictures of the current layer, in output order, until the end of the current CLVS or up to but excluding the decoded picture that follows the current decoded picture in output order within the current CLVS and is associated with a subsequent NNPFC SEI message, in decoding order, having that particular nnpfc_id value within the current CLVS, whichever is earlier.

When an NNPFC SEI message nnpfcCurr is not the first NNPFC SEI message, in decoding order, that has a particular nnpfc_id value within the current CLVS, is not a repetition of the first NNPFC SEI message with that particular nnpfc_id (i.e., the value of nnpfc_base_flag is equal to 0), and the value of nnpfc_property_present_flag is equal to 1, the following constraints apply:
The value of nnpfc_purpose in the NNPFC SEI message shall be the same as the value of nnpfc_purpose in the first NNPFC SEI message, in decoding order, that has that particular nnpfc_id value within the current CLVS.
The values of syntax elements following nnpfc_base_flag and preceding nnpfc_complexity_info_present_flag, in decoding order, in the NNPFC SEI message shall be the same as the values of corresponding syntax elements in the first NNPFC SEI message, in decoding order, that has that particular nnpfc_id value within the current CLVS.
Either nnpfc_complexity_info_present_flag shall be equal to 0 or both nnpfc_complexity_info_present_flag shall be equal to 1 in the first NNPFC SEI message, in decoding order, that has that particular nnpfc_id value within the current CLVS (denoted as nnpfcBase below) and all the following apply:
   nnpfc_parameter_parameter_type_idc in nnpfcCurr shall be equal to nnpfc_parameter_parameter_type_idc in nnpfcBase.
   nnpfc_log 2_parameter_bit_length_minus3 in nnpfcCurr, when present, shall be less than or equal to nnpfc_log 2_parameter_bit_length_minus3 in nnpfcBase.
   If nnpfc_num_parameters_idc in nnpfcBase is equal to 0, nnpfc_num_parameters_idc in nnpfcCurr shall be equal to 0.
   Otherwise (nnpfc_num_parameters_idc in nnpfcBase is greater than 0), nnpfc_num_parameters_idc in nnpfcCurr shall be greater than 0 and less than or equal to nnpfc_num_parameters_idc in nnpfcBase.
   If nnpfc_num_kmac_operations_idc in nnpfcBase is equal to 0, nnpfc_num_kmac_operations_idc in nnpfcCurr shall be equal to 0.
   Otherwise (nnpfc_num_kmac_operations_idc in nnpfcBase is greater than 0), nnpfc_num_kmac_operations_idc in nnpfcCurr shall be greater than 0 and less than or equal to nnpfc_num_kmac_operations_idc in nnpfcBase.
   If nnpfc_total_kilobyte_size in nnpfcBase is equal to 0, nnpfc_total_kilobyte_size in nnpfcCurr shall be equal to 0.
Otherwise (nnpfc_total_kilobyte_size in nnpfcBase is greater than 0), nnpfc_total_kilobyte_size in nnpfcCurr shall be greater than 0 and less than or equal to nnpfc_total_kilobyte_size in nnpfcBase.

nnpfc_out_sub_c_flag specifies the values of the variables outSubWidthC and outSubHeightC when nnpfc_purpose & 0x02 is not equal to 0. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When ChromaFormatIdc is equal to 2 and nnpfc_out_sub_c_flag is present, the value of nnpfc_out_sub_c_flag shall be equal to 1.

nnpfc_out_colour_format_idc, when nnpfc_purpose & 0x20 is not equal to 0, specifies the color format of the NNPF output and consequently the values of the variables outSubWidthC and outSubHeightC. nnpfc_out_colour_format_idc equal to 1 specifies that the color format of the NNPF output is the 4:2:0 format and outSubWidthC and outSubHeightC are both equal to 2. nnpfc_out_colour_format_idc equal to 2 specifies that the color format of the NNPF output is the 4:2:2 format and outSubWidthC is equal to 2 and outSubHeightC is equal to 1. nnpfc_out_colour_format_idc equal to 3 specifies that the color format of the NNPF output is the 4:2:4 format and outSubWidthC and outSubHeightC are both equal to 1. The value of nnpfc_out_colour_format_idc shall not be equal to 0.

When nnpfc_purpose & 0x02 and nnpfc_purpose & 0x20 are both equal to 0, outSubWidthC and outSubHeightC are inferred to be equal to SubWidthC and SubHeightC, respectively.

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16−1, inclusive. The value of nnpfc_pic_height_in_luma_samples shall be in the range of CroppedHeight to CroppedHeight*16−1, inclusive.

nnpfc_num_input_pics_minus1 plus 1 specifies the number of decoded output pictures used as input for the NNPF. The value of nnpfc_num_input_pics_minus1 shall be in the range of 0 to 63, inclusive. When nnpfc_purpose & 0x08 is not equal to 0, the value of nnpfc_num_input_pics_minus1 shall be greater than 0.

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one i in the range of 0 to nnpfc_num_input_pics_minus1-1, inclusive.

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture.

The variables numInputPics, specifying the number of pictures used as input for the NNPF, and numOutputPics, specifying the total number of pictures resulting from the NNPF, are derived as follows:

| numInputPics = nnpfc_num_input_pics_minus1 + 1 | |
|---|---|
| if( ( nnpfc_purpose & 0x08 ) != 0 ) { | |
| for( i = 0, numOutputPics = 0; i < numInputPics; i++ ) | |
| if( nnpfc_input_pic_output_flag[ i ] ) | |
| numOutputPics++ | |
| for( i = 0; i <= numInputPics − 2; i++ ) | (76) |

numOutputPics += nnpfc_interpolated_pics[ i ]
} else
numOutputPics = 1

nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the NNPF. When nnpfc_inp_format_idc is equal to 0, the input values to the NNPF are real numbers and the functions InpY( ) and InpC( ) are specified as follows:

$$InpY ( x ) = x \div ( ( 1 << {BitDepth}_{Y} ) - 1 ) \qquad ( 77 )$$

$$InpC ( x ) = x \div ( ( 1 << {BitDepth}_{C} ) - 1 ) \qquad ( 78 )$$

When nnpfc_inp_format_idc is equal to 1, the input values to the NNPF are unsigned integer numbers and the functions InpY( ) and InpC( ) are specified as follows:

shiftY = BitDepthY − inpTensorBitDepthY
if( inpTensorBitDepthY >= BitDepthY)

| | |
|---|---|
| InpY( x ) = x << ( inpTensorBitDepthY − BitDepthY ) | (79) |

else
InpY( x ) = Clip3(0, ( 1 << inpTensorBitDepthY ) − 1, ( x + ( 1 << ( shiftY − 1 ) ) ) >> shiftY )
shiftC = BitDepthC − inpTensorBitDepthC
if( inpTensorBitDepthC >= BitDepthC )

| | |
|---|---|
| InpC( x ) = x << ( inpTensorBitDepthC − BitDepthC ) | (80) |

else
InpC( x ) = Clip3(0, ( 1 << inpTensorBitDepthC ) − 1, ( x + ( 1 << ( shiftC − 1 ) ) ) >> shiftC )

The variable inp TensorBitDepthY is derived from the syntax element nnpfc_inp_tensor_luma_bitdepth_minus8 as specified below. The variable inpTensorBitDepthC is derived from the syntax element nnpfc_inp_tensor_chroma_bitdepth_minus8 as specified below.

Values of nnpfc_inp_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc.

nnpfc_inp_tensor_luma_bitdepth_minus8 plus 8 specifies the bit depth of luma sample values in the input integer tensor. The value of inpTensorBitDepthY is derived as follows:

$${inpTensorBitDepth}_{Y} = nnpfc\_inp \_tensor \_luma \_bitdepth \_minus8 + 8 \qquad ( 81 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepthC is derived as follows:

$${inpTensorBitDepth}_{C} = nnpfc\_inp \_tensor \_chroma \_bitdepth \_minus8 + 8 \qquad ( 82 )$$

It is a requirement of bitstream conformance that the value of nnpfc_inp_tensor_chroma_bitdepth_minus8 shall be in the range of 0 to 24, inclusive.

nnpfc_inp_order_idc indicates the method of ordering the sample arrays of a cropped decoded output picture as one of the input pictures to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 21 contains an informative description of nnpfc_inp_order_idc values.

TABLE 21
Description of nnpfc_inp_order_idc values

| nnpfc_inp_order_idc | Description |
|---|---|
| 0 | If nnpfc_auxiliary_inp_idc is equal to 0, one luma matrix is present |
| | in the input tensor for each input picture, and the number of channels |
| | is 1. Otherwise when nnpfc_auxiliary_inp_idc is equal to 1, one |
| | luma matrix and one auxiliary input matrix are present, and the |
| | number of channels is 2. |
| 1 | If nnpfc_auxiliary_inp_idc is equal to 0, two chroma matrices are |
| | present in the input tensor, and the number of channels is 2. Otherwise |
| | when nnpfc_auxiliary_inp_idc is equal to 1, two chroma matrices |
| | and one auxiliary input matrix are present, and the number of |
| | channels is 3. |
| 2 | If nnpfc_auxiliary_inp_idc is equal to 0, one luma and two chroma |
| | matrices are present in the input tensor, and the number of channels |
| | is 3. Otherwise when nnpfc_auxiliary_inp_idc is equal to 1, one |
| | luma matrix, two chroma matrices and one auxiliary input matrix are |
| | present, and the number of channels is 4. |
| 3 | If nnpfc_auxiliary_inp_idc is equal to 0, four luma matrices and |
| | two chroma matrices are present in the input tensor, and the number |
| | of channels is 6. Otherwise when nnpfc_auxiliary_inp_idc is equal |
| | to 1, four luma matrices, two chroma matrices, and one auxiliary |
| | input matrix are present in the input tensor, and the number of |
| | channels is 7. The luma channels are derived in an interleaved |
| | manner as illustrated in FIG. 12. This nnpfc_inp_order_idc can |
| | only be used when the input chroma format is 4:2:0. |
| 4 . . . 255 | Reserved |

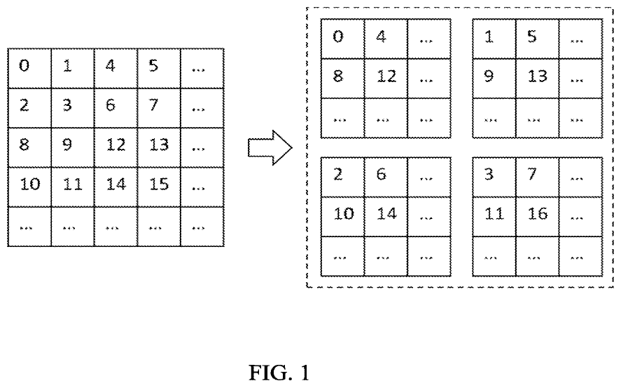

FIG. 1 illustrates an example of deriving luma channels from a luma component.

A patch is a rectangular array of samples from a component (e.g., a luma or chroma component) of a picture.

nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 84.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

When nnpfc_auxiliary_inp_idc is equal to 1, the variable strengthControlScaledVal is derived as follows:

if( nnpfc_inp_format_idc = = 1 )
strengthControlScaledVal = Floor ( StrengthControlVal * ( ( 1 << inpTensorBitDepthY ) − 1 ) ) (83)
else
strengthControlScaledVal = StrengthControlVal

The process DeriveInputTensors( ) for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
if( nnpfc_inp_order_idc = = 0 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      inpVal = InpY( InpSampleVal( cTop + yP, cLeft + xP, CroppedHeight,
              CroppedWidth, CroppedYPic[ i ] ) )
      yPovlp = yP + nnpfc_overlap
      xPovlp = xP + nnpfc_overlap
      if( !nnpfc_component_last_flag )
        inputTensor[ 0 ][ i ][ 0 ][ yPovlp ][ xPovlp ] = inpVal
      else
        inputTensor[ 0 ][ i ][ yPovlp ][ xPovlp ][ 0 ] = inpVal
      if( nnpfc_auxiliary_inp_idc = = 1 )
        if( !nnpfc_component_last_flag )
        inputTensor[ 0 ][ i ][ 1 ][ yPovlp ][ xPovlp ] = strengthControlScaledVal
        else
        inputTensor[ 0 ][ i ][ yPovlp ][ xPovlp ][ 1 ] = strengthControlScaledVal
    }
```

| | |
|---|---|
| else if( nnpfc_inp_order_idc = = 1 ) | (84) |

```
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      inpCbVal = InpC( InpSampleVal( cTop + yP, cLeft + xP, CroppedHeight / SubHeightC,
          CroppedWidth / SubWidthC, CroppedCbPic[ i ] ) )
      inpCrVal = InpC( InpSampleVal( cTop + yP, cLeft + xP, CroppedHeight / SubHeightC,
          CroppedWidth / SubWidthC, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpCbVal
        inputTensor[ 0 ][ i ][ 1 ][ yPovlp ][ xPovlp ] = inpCrVal
      } else {
        inputTensor[ 0 ][ i ][ yPovlp ][ xPovlp ][ 0 ] = inpCbVal
        inputTensor[ 0 ][ i ][ yPovlp ][ xPovlp ][ 1 ] = inpCrVal
      }
      if( nnpfc_auxiliary_inp_idc = = 1 )
        if( !nnpfc_component_last_flag )
        inputTensor[ 0 ][ i ][ 2 ][ yPovlp ][ xPovlp ] = strengthControlScaledVal
        else
        inputTensor[ 0 ][ i ][ yPovlp ][ xPovlp ][ 2 ] = strengthControlScaledVal
    }
else if( nnpfc_inp_order_idc = = 2 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      yY = cTop + yP
      xY = cLeft + xP
      yC = yY / SubHeightC
      xC = xY / SubWidthC
      inpYVal = InpY( InpSampleVal( yY, xY, CroppedHeight,
              CroppedWidth, CroppedYPic[ i ] ) )
      inpCbVal = InpC( InpSampleVal( yC, xC, CroppedHeight / SubHeightC,
          CroppedWidth / SubWidthC, CroppedCbPic[ i ] ) )
      inpCrVal = InpC( InpSampleVal( yC, xC, CroppedHeight / SubHeightC,
          CroppedWidth / SubWidthC, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpYVal
        inputTensor[ 0 ][ i ][ 1 ][ yPovlp ][ xPovlp ] = inpCbVal
        inputTensor[ 0 ][ i ][ 2 ][ yPovlp ][ xPovlp ] = inpCrVal
      } else {
        inputTensor[ 0 ][ i ][ yPovlp ][ xPovlp ][ 0 ] = inpYVal
        inputTensor[ 0 ][ i ][ yPovlp ][ xPovlp ][ 1 ] = inpCbVal
        inputTensor[ 0 ][ i ][ yPovlp ][ xPovlp ][ 2 ] = inpCrVal
      }
      if( nnpfc_auxiliary_inp_idc = = 1 )
        if( !nnpfc_component_last_flag )
        inputTensor[ 0 ][ i ][ 3 ][ yPovlp ][ xPovlp ] = strengthControlScaledVal
        else
        inputTensor[ 0 ][ i ][ yPovlp ][ xPovlp ][ 3 ] = strengthControlScaledVal
    }
else if( nnpfc_inp_order_idc = = 3 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      yTL = cTop + yP * 2
      xTL = cLeft + xP * 2
      yBR = yTL + 1
      xBR = xTL + 1
      yC = cTop / 2 + yP
      xC = cLeft / 2 + xP
      inpTLVal = InpY( InpSampleVal( yTL, xTL, CroppedHeight,
              CroppedWidth, CroppedYPic[ i ] ) )
      inpTRVal = InpY( InpSampleVal( yTL, xBR, CroppedHeight,
              CroppedWidth, CroppedYPic[ i ] ) )
      inpBLVal = InpY( InpSampleVal( yBR, xTL, CroppedHeight,
              CroppedWidth, CroppedYPic[ i ] ) )
      inpBRVal = InpY( InpSampleVal( yBR, xBR, CroppedHeight,
              CroppedWidth, CroppedYPic[ i ] ) )
      inpCbVal = InpC( InpSampleVal( yC, xC, CroppedHeight / 2,
            CroppedWidth / 2, CroppedCbPic[ i ] ) )
      inpCrVal = InpC( InpSampleVal( yC, xC, CroppedHeight / 2,
            CroppedWidth / 2, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpTLVal
        inputTensor[ 0 ][ i ][ 1 ][ yPovlp ][ xPovlp ] = inpTRVal
        inputTensor[ 0 ][ i ][ 2 ][ yPovlp ][ xPovlp ] = inpBLVal
        inputTensor[ 0 ][ i ][ 3 ][ yPovlp ][ xPovlp ] = inpBRVal
        inputTensor[ 0 ][ i ][ 4 ][ yPovlp ][ xPovlp ] = inpCbVal
        inputTensor[ 0 ][ i ][ 5 ][ yPovlp ][ xPovlp ] = inpCrVal
      } else {
        inputTensor[ 0 ][ i ][ yPovlp ][ xPovlp ][ 0 ] = inpTLVal
        inputTensor[ 0 ][ i ][ yPovlp ][ xPovlp ][ 1 ] = inpTRVal
        inputTensor[ 0 ][ i ][ yPovlp ][ xPovlp ][ 2 ] = inpBLVal
        inputTensor[ 0 ][ i ][ yPovlp ][ xPovlp ][ 3 ] = inpBRVal
        inputTensor[ 0 ][ i ][ yPovlp ][ xPovlp ][ 4 ] = inpCbVal
        inputTensor[ 0 ][ i ][ yPovlp ][ xPovlp ][ 5 ] = inpCrVal
      }
      if( nnpfc_auxiliary_inp_idc = = 1 )
        if( !nnpfc_component_last_flag )
        inputTensor[ 0 ][ i ][ 6 ][ yPovlp ][ xPovlp ] = strengthControlScaledVal
        else
        inputTensor[ 0 ][ i ][ yPovlp ][ xPovlp ][ 6 ] = strengthControlScaledVal
    }
}
```

nnpfc_separate_colour_description_present_flag equal to 1 indicates that a distinct combination of color primaries, transfer characteristics, and matrix coefficients for the picture resulting from the NNPF is specified in the SEI message syntax structure. nnpfc_separate_colour_description_present_flag equal to 0 indicates that the combination of color primaries, transfer characteristics, and matrix coefficients for the picture resulting from the NNPF is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the color primaries of the picture resulting from applying the NNPF specified in the SEI message, rather than the color primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the NNPF specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the NNPF specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1<< (nnpfc_out_tensor_luma_bitdepth_minus8+8))−1, inclusive, and the chroma sample values output by the NNPF are unsigned integer numbers in the range of 0 to (1<<(nnpfc_out_tensor_chroma_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive.

nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive.

When nnpfc_purpose & 0x10 is not equal to 0, the value of nnpfc_out_format_idc shall be equal to 1 and at least one of the following conditions shall be true:
nnpfc_out_tensor_luma_bitdepth_minus8+8 is greater than BitDepth_{Y}.
nnpfc_out_tensor_chroma_bitdepth_minus8+8 is greater than BitDepth_{C}.

nnpfc_out_order_idc indicates the output order of samples resulting from the NNPF.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose & 0x02 is not equal to 0, nnpfc_out_order_idc shall not be equal to 3.

Table 22 contains an informative description of nnpfc_out_order_idc values.

TABLE 22
Description of nnpfc_out_order_idc values

| nnpfc_out_order_idc | Description |
|---|---|
| 0 | Only the luma matrix is present in the output |
| | tensor, thus the number of channels is 1. |
| 1 | Only the chroma matrices are present in the |
| | output tensor, thus the number of |
| | channels is 2. |
| 2 | The luma and chroma matrices are present in the |
| | output tensor, thus the number of channels is 3. |
| 3 | Four luma matrices and two chroma matrices are |
| | present in the output tensor, thus the number of |
| | channels is 6. This nnpfc_out_order_idc can |
| | only be used when the output chroma |
| | format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numOutputPics; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
```

| | |
|---|---|
| else if( nnpfc_out_order_idc = = 1 ) | (85) |

```
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = (xP / outSubWidthC ) * outSubWidthC
        if ( yY < nnpfc_pic_height_in_luma_samples && xY < nnpfc_pic_width_in_luma_samples)
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

nnpfc_overlap indicates the overlapping horizontal and vertical sample counts of adjacent input tensors of the NNPF. The value of nnpfc_overlap shall be in the range of 0 to 16 383, inclusive.

nnpfc_constant_patch_size_flag equal to 1 indicates that the NNPF accepts exactly the patch size indicated by nnpfc_patch_width_minus1 and nnpfc_patch_height_minus1 as input. nnpfc_constant_patch_size_flag equal to 0 indicates that the NNPF accepts as input any patch size with width inpPatch Width and height inpPatchHeight such that the width of an extended patch (i.e., a patch plus the overlapping area), which is equal to inpPatchWidth+2*nnpfc_overlap, is a positive integer multiple of nnpfc_extended_patch_width_cd_delta_minus1+1+2*nnpfc_overlap, and the height of the extended patch, which is equal to inpPatchHeight+2*nnpfc_overlap, is a positive integer multiple of nnpfc_extended_patch_height_cd_delta_minus1+1+2*nnpfc_overlap.

nnpfc_patch_width_minus1 plus 1, when nnpfc_constant_patch_size_flag equal to 1, indicates the horizontal sample counts of the patch size required for the input to the NNPF. The value of nnpfc_patch_width_minus1 shall be in the range of 0 to Min (32 766, CroppedWidth−1), inclusive.

nnpfc_patch_height_minus1 plus 1, when nnpfc_constant_patch_size_flag equal to 1, indicates the vertical sample counts of the patch size required for the input to the NNPF. The value of nnpfc_patch_height_minus1 shall be in the range of 0 to Min (32 766, CroppedHeight−1), inclusive.

nnpfc_extended_patch_width_cd_delta_minus1 plus 1 plus 2*nnpfc_overlap, when nnpfc_constant_patch_size_flag equal to 0, indicates a common divisor of all allowed values of the width of an extended patch required for the input to the NNPF. The value of nnpfc_extended_patch_width_cd_delta_minus1 shall be in the range of 0 to Min (32 766, CroppedWidth−1), inclusive.

nnpfc_extended_patch_height_cd_delta_minus1 plus 1 plus 2*nnpfc_overlap, when nnpfc_constant_patch_size_flag equal to 0, indicates a common divisor of all allowed values of the height of an extended patch required for the input to the NNPF. The value of nnpfc_extended_patch_height_cd_delta_minus1 shall be in the range of 0 to Min (32 766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth+2*nnpfc_overlap shall be a positive integer multiple ofnnpfc_extended_patch_width_cd_delta_minus1+1+2*nnpfc_overlap and inpPatch Width shall be less than or equal to CroppedWidth. The value of inpPatchHeight+2*nnpfc_overlap shall be a positive integer multiple ofnnpfc_extended_patch_height_cd_delta_minus1+1+2*nnpfc_overlap and inpPatchHeight shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

The variables outPatchWidth, outPatchHeight, horCScaling, verCScaling, outPatchCWidth, and outPatchCHeight are derived as follows:

$$outPatchWidth = ( nnpfc\_pic \_width \_in \_luma \_samples * inpPatchWidth ) / CroppedWidth \qquad ( 86 )$$

$$outPatchHeight = ( nnpfc\_pic \_height \_in \_luma \_samples * inpPatchHeight ) / CroppedHeight \qquad ( 87 )$$

$$horCScaling = SubWidthC / outSubWidthC \qquad ( 88 )$$

$$verCScaling = SubHeightC / outSubHeightC \qquad ( 89 )$$

$$outPatchCWidth = outPatchWidth * horCScaling \qquad ( 90 )$$

$$outPatchCHeight = outPatchHeight * verCScaling \qquad ( 91 )$$

It is a requirement of bitstream conformance that outPatch Width*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 23. The value of nnpfc_padding_type shall be in the range of 0 to 15, inclusive.

TABLE 23
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sample Val derived as follows:

NOTE 6—For the inputs to the function InpSampleVal ( ) the vertical location is listed before the horizontal location for compatibility with input tensor conventions of some inference engines.

```
if( nnpfc_padding_type = = 0 )
  if( y < 0 ∥ x < 0 ∥ y >= picHeight ∥ x >= picWidth )
    sampleVal = 0
  else
```

| | |
|---|---|
| sampleVal = croppedPic[ x ][ y ] | (92) |

```
else if( nnpfc_padding_type = = 1 )
  sampleVal = croppedPic[ Clip3( 0, picWidth − 1, x ) ][ Clip3( 0, picHeight − 1, y ) ]
else if( nnpfc_padding_type = = 2 )
  sampleVal = croppedPic[ Reflect( picWidth − 1, x ) ][ Reflect( picHeight − 1, y ) ]
else if( nnpfc_padding_type = = 3 )
  if( y >= 0 && y < picHeight )
    sampleVal = croppedPic[ Wrap( picWidth − 1, x ) ][ y ]
else if( nnpfc_padding_type = = 4 )
  if( y < 0 ∥ x < 0 ∥ y >= picHeight ∥ x >= picWidth )
    sampleVal[ 0 ] = nnpfc_luma_padding_val
    sampleVal[ 1 ] = nnpfc_cb_padding_val
    sampleVal[ 2 ] = nnpfc_cr_padding_val
  else
    sampleVal = croppedPic[ x ][ y ]
```

The following example process may be used, with the NNPF PostProcessingFilter( ) to generate, in a patch-wise manner, the filtered and/or interpolated picture(s), which contain Y, Cb, and Cr sample arrays FilteredYPic, FilteredCbPic, and FilteredCrPic, respectively, as indicated by nnpfc_out_order_idc:

```
if( nnpfc_inp_order_idc = = 0 ∥ nnpfc_inp_order_idc = = 2 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
```

| | |
|---|---|
| for( cLeft = 0; cLeft < CroppedWidth / SubWidthC; cLeft += inpPatchWidth ) { | (93) |

```
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

The order of the pictures in the stored output tensor is in output order, and the output order generated by applying the NNPF in output order is interpreted to be in output order (and not conflicting with the output order of the input pictures).

nnpfc_complexity_info_present_flag equal to 1 specifies that one or more syntax elements that indicate the complexity of the NNPF associated with the nnpfc_id are present. nnpfc_complexity_info_present_flag equal to 0 specifies that no syntax elements that indicates the complexity of the NNPF associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present the neural network does not use parameters of bit length greater than 1.

nnpfc_num_parameters_idc indicates the maximum number of neural network parameters for the NNPF in units of a power of 2 048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$maxNumParameters = ( 2 \; 048 << nnpfc\_num\_parameters\_idc ) - 1 \qquad ( 94 )$$

It is a requirement of bitstream conformance that the number of neural network parameters of the NNPF shall be less than or equal to maxNumParameters.

nnpfc_num_kmac_operations_idc greater than 0 indicates that the maximum number of multiply-accumulate operations per sample of the NNPF is less than or equal to nnpfc_num_kmac_operations_idc*1 000. nnpfc_num_kmac_operations_idc equal to 0 indicates that the maximum number of multiply-accumulate operations of the network is unknown. The value of nnpfc_num_kmac_operations_idc shall be in the range of 0 to 232-2, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8 000, rounded up. nnpfc_total_kilobyte_size equal to 0 indicates that the total size required to store the parameters for the neural network is unknown. The value of nnpfc_total_kilobyte_size shall be in the range of 0 to 232-2, inclusive.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) | |
| nnpfa_persistence_flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter (NNPF), identified by nnpfa_target_id, for post-processing filtering of a set of pictures. For a particular picture for which the NNPF is activated, the target NNPF is the NNPF specified by the last NNPFC SEI message with nnpfc_id equal to nnpfa_target_id, that precedes the first VCL NAL unit of the current picture in decoding order that is not a repetition of the NNPFC SEI message that contains the base NNPF.

NOTE 1—There can be several NNPFA SEI messages present for the same picture, for example, when the NNPFs are meant for different purposes or for filtering of different color components.

nnpfa_target_id indicates the target NNPF, which is specified by one or more NNPFC SEI messages that pertain to the current picture and have nnpfc_id equal to nnfpa_target_id.

The value of nnpfa_target_id shall be in the range of 0 to 232−2, inclusive. Values of nnpfa_target_id from 256 to 511, inclusive, and from 231 to 232−2, inclusive, are reserved for future use by ITU-T|ISO/IEC. Decoders conforming to this edition of this document encountering an NNPFA SEI message with nnpfa_target_id in the range of 256 to 511, inclusive, or in the range of 231 to 232-2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target NNPF established by any previous NNPFA SEI message with the same nnpfa_target_id as the current SEI message is cancelled, i.e., the target NNPF is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target NNPF for the current layer.

nnpfa_persistence_flag equal to 0 specifies that the target NNPF may be used for post-processing filtering for the current picture only.

nnpfa_persistence_flag equal to 1 specifies that the target NNPF may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE 2—The target NNPF is not applied for this subsequent picture in the current layer associated with a NNPFA SEI message with the same nnpfa_target_id as the current SEI message and nnpfa_cancel_flag equal to 1.

Let the nnpfcTargetPictures be the set of pictures to which the last NNPFC SEI message with nnpfc_id equal to nnpfa_target_id that precedes the current NNPFA SEI message in decoding order pertains. Let nnpfaTargetPictures be the set of pictures for which the target NNPF is activated by the current NNPFA SEI message. It is a requirement of bitstream conformance that any picture included in nnpfaTargetPictures shall also be included in nnpfcTargetPictures.

### 3.4 Use of the NNPFC SEI Message in a VVC Bitstream

JVET-AC2005 [6] includes the specification of use of the NNPFC SEI message in an VVC bitstream, as follows:

### D.2.1 General SEI Payload Syntax

| | Descriptor |
|---|---|
| sei_payload( payloadType, payloadSize ) { | |
| SeiExtensionBitsPresentFlag = 0 | |
| if( nal_unit_type = = PREFIX_SEI_NUT ) | |
| if( payloadType = = 0 ) | |
| buffering_period( payloadSize ) | |
| ... | |
| else if( payloadType = = 210) /* Specified in Rec. ITU-T H.274 \| ISO/IEC 23002-7 | |
| */ | |
| nn_post_filter_characteristics( payloadSize ) | |
| else if( payloadType = = 211 ) /* Specified in Rec. ITU-T H.274 \| ISO/IEC 23002-7 | |
| */ | |
| nn_post_filter_activation( payloadSize ) | |
| ... | |
| if( SeiExtensionBitsPresentFlag ∥ more_data_in_payload( ) ) { | |
| if( payload_extension_present( ) ) | |
| sei_reserved_payload_extension_data | u(v) |
| sei_payload_bit_equal_to_one /* equal to 1 */ | f(1) |
| while( !byte_aligned( ) ) | |
| sei_payload_bit_equal_to_zero /* equal to 0 */ | f(1) |
| } | |
| } | |

### D.12.11 Use of the Neural Network Post-Filter Characteristics SEI Message

Let currCodedPic be the coded picture for which the neural-network post-processing filter (NNPF) defined by the neural-network post-filter characteristics (NNPFC) SEI message is activated by a neural-network post-filter activation (NNPFA) SEI message.

The variable pictureRateUpsamplingFlag is set equal to (nnpfc_purpose & 0x08)!=0.

The variable numInputPics is set equal to nnpfc_num_input_pics_minus1+1.

The array inputPicPoc[i] for all values of i in the range of 0 to numInputPics−1, inclusive, specifying the picture order count values of the input pictures for the NNPF, is derived as follows:
inputPicPoc[0] is set equal to PicOrderCntVal of currCodedPic.
When numInputPics is greater than 1, the following applies for each value of i in the range of 1 to numInputPics−1, inclusive, in increasing order of i:
   If currCodedPic is associated with a frame packing arrangement SEI message with fp_arrangement_type equal to 5 and a particular value of fp_current_frame_is_frame0_flag, inputPicPoc[i] is set equal to PicOrderCntVal of the picture that precedes, in output order, the picture associated with index i−1 and is associated with a frame packing arrangement SEI message with fp_arrangement_type equal to 5 and the same value of fp_current_frame_is_frame0_flag.
Otherwise (currCodedPic is not associated with a frame packing arrangement SEI message with fp_arrangement_type equal to 5), inputPicPoc[i] is set equal to PicOrderCntVal of the picture that precedes, in output order, the picture associated with index i−1.

For purposes of interpretation of the NNPFC SEI message, the following variables are specified:
If pictureRateUpsamplingFlag is equal to 1 and there is a second NNPF that is defined by at least one NNPFC SEI message, is activated by an NNPFA SEI message for currCodedPic, and has nnpfc_purpose equal to 4, the following applies:
   CroppedWidth is set equal to nnpfc_pic_width_in_luma_samples defined for the second NNPF.
   CroppedHeight is set equal to nnpfc_pic_height_in_luma_samples defined for the second NNPF.
Otherwise, the following applies:
   CroppedWidth is set equal to the value of pps_pic_width_in_luma_samples−SubWidthC*(pps_conf_win_left_offset+pps_conf_win_right_offset) for currCodedPic.
   CroppedHeight is set equal to the value of pps_pic_height_in_luma_samples−SubHeightC*(pps_conf_win_top_offset+pps_conf_win_bottom_offset) for currCodedPic.
The luma sample arrays CroppedYPic[i] and the chroma sample arrays CroppedCbPic[i] and CroppedCrPic[i], when present, are derived as follows for each value of i in the range of 0 to numInputPics−1, inclusive:
   Let sourcePic be the cropped decoded output picture that has PicOrderCntVal equal to inputPicPoc[i] in the CLVS containing currCodedPic.
   If pictureRateUpsamplingFlag is equal to 0, the following applies:
      The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.
Otherwise (pictureRateUpsamplingFlag is equal to 1), the following applies:
   The variable sourceWidth is set equal to the value of pps_pic_width_in_luma_samples−SubWidthC*(pps_conf_win_left_offset+pps_conf_win_right_offset) for sourcePic.
   The variable sourceHeight is set equal to the value of pps_pic_height_in_luma_samples−SubHeightC*(pps_conf_win_top_offset+pps_conf_win_bottom_offset) for sourcePic.
   If source Width is equal to CroppedWidth and sourceHeight is equal to CroppedHeight, inputPic is set to be the same as sourcePic.
   Otherwise (sourceWidth is not equal to CroppedWidth or sourceHeight is not equal to CroppedHeight), the following applies:
      There shall be an NNPF, hereafter referred to as the super resolution NNPF, that is defined by at least one NNPFC SEI message, is activated by an NNPFA SEI message for sourcePic, and has nnpfc_purpose equal to 4, nnpfc_pic_width_in_luma_samples equal to CroppedWidth and nnpfc_pic_height_in_luma_samples equal to CroppedHeight.
      inputPic is set to be the output of the neural-network inference of the super resolution NNPF with sourcePic being an input.
   The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of inputPic.
BitDepth and BitDepth_{C} are both set equal to BitDepth.
ChromaFormatIdc is set equal to sps_chroma_format_idc.
StrengthControlVal is set equal to the value of SliceQpy÷63 of the first slice of currCodedPic.

There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 3.5 SEI Processing Order SEI Message

JVET-AB2027 [7] includes the specification of the SEI processing order SEI message, which carries information indicating the preferred processing order, as determined by the encoder (i.e., the content producer), for different types of SEI messages that may be present in the bitstream.

The SEI processing order SEI message was designed primarily for indicating the preferred processing order of different post-processing filters signalled by different types of SEI messages.

The syntax and semantics of the SEI processing order SEI message in JVET-AB2027 are as follows:

### D.11 SEI Processing Order SEI Message

### D.11.1 SEI Processing Order SEI Message Syntax

| | Descriptor |
|---|---|
| sei_processing_order( payloadSize ) { | |
| for( i = 0, b = 0; b < payloadSize; i++, b += 4 ) { | |
| po_sei_payload_type[ i ] | u(16) |
| po_sei_processing_order[ i ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in the bitstream. When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two pairs of the syntax elements po_sei_payload_type[i] and po_sei_processing_order[i], i.e., the syntax elements po_sei_payload_type[0], po_sei_processing_order[0], po_sei_payload_type[1], and po_sei_processing_order[1] shall be present.

po_sei_payload_type[i] specifies the value of payloadType for the i-th SEI message for which information is provided in the SEI processing order SEI message. The values of po_sei_payload_type[m] and po_sei_payload_type[n] shall not be identical when m is not equal to n.

po_sei_processing_order[i] indicates the preferred order of processing any SEI message with payloadType equal to po_sei_payload_type[i]. For any two different integer values of m and n that are greater than or equal to 0, po_sei_processing_order[m] less than po_sei_processing_order[n] indicates any SEI message with payloadType equal to po_sei_payload_type[m], when present, should be processed before any SEI message with payloadType equal to po_sei_payload_type[n], when present, and po_sei_processing_order[m] equal to po_sei_processing_order[n] indicates that there is no preferred order of processing between the SEI messages with payloadTypes equal to po_sei_payload_type[m] and po_sei_payload_type[n].

### 3.6 Updated SEI Processing Order SEI Message

JVET-AC2027 [8] includes the updated specification of the SEI processing order SEI message, as follows:

### D.11 SEI Processing Order SEI Message

### D.11.1 SEI Processing Order SEI Message Syntax

| | Descriptor |
|---|---|
| sei_processing_order( payloadSize ) { | |
| for( i = 0, b = 0; b < payloadSize; i++, b += 4 ) { | |
| po_sei_payload_type[ i ] | u(16) |
| if( po_sei_payload_type[ i ] = = 4 ) { | |
| po_num_t35_byte[ i ] | b(8) |
| b++ | |
| for( j = 0; j < po_num_t35_bytes[ i ]; j++ ) | |
| po_t35_byte[ i ][ j ] | b(8) |
| b += po_num_t35_byte[ i ] | |
| } | |
| po_sei_processing_order[ i ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in a CVS.

When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless they are both equal to 4.

po_num_t35_byte[i], when present, specifies the number of bytes associated with the i-th user data registered by Recommendation ITU-T T.35 SEI message for which preferred processing order information is provided in the SEI processing order SEI message. When not present, the value of po_num_t35_byte[i] is inferred to be equal to 0. po_num_t35_byte[i] equal to 0 indicates that there is no preferred order of processing between user data registered by Recommendation ITU-T T.35 SEI messages.

po_t35_byte[i][j], when present, specifies the j-th byte value of the i-th user data registered by Recommendation ITU-T T.35 SEI message.

po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_t35_byte[m][p] for p ranging from 0 to po_num_t35_byte[m]−1, inclusive, should be processed before any SEI message type with payloadType equal to po_sei_payload_type[n], and, when present, bytes po_t35_byte[n][q] for q ranging from 0 to po_num_t35_byte[n]−1, inclusive, and po_sei_processing_order[m] equal to po_sei_processing_order[n] indicates that there is no preferred order of processing between the SEI message types. When there are multiple user data registered by Recommendation ITU-T T.35 SEI messages with the same content in a CVS, they shall have the same SEI processing order value.

### 4. TECHNICAL PROBLEMS SOLVED BY DISCLOSED EMBODIMENTS

An example design for the neural-network post-filter characteristics (NNPFC) SEI message and the neural-network post-filter activation (NNPFA) SEI message has the following problems:

First, activation of multiple NNPFs for a picture is allowed. However, when there are multiple NNPFs activated for a picture, except for a special case of two NNPFs for spatial resolution upsampling and picture rate upsampling, for all other cases, it is unclear the order in which the multiple activated NNPFs should be applied. On the other hand, the preferred processing order of different types of post-processing filters signalled by different types of SEI messages can be indicated using the SEI process order SEI message.

Second, it is unclear how to process a picture for which an NNPF is activated and that is also associated with an SEI message signalling a non-NNPF post-processing filter, e.g., denoising, film grain, etc.

Third, it is similarly unclear how to process a picture for which an NNPF is activated and that is also associated with a non-NNPF SEI message e.g., which indicates flipping and/or rotation of the decoded picture.

### 5. A LISTING OF SOLUTIONS AND EMBODIMENTS

To solve the above-described problems, methods as summarized below are disclosed. The aspects should be considered as examples to explain the general concepts and should not be interpreted in a narrow way. Furthermore, these examples can be applied individually or combined in any manner.
1) To solve problem 1, the processing order or preferred processing order of different post-processing filters, including zero or more NNPFs and zero or more non-NNPF post-processing filters, is signalled in the SEI processing order SEI message, and one or more of the following aspects are specified:
   a. In one example, an indication of the number of different SEI payload types for which information is provided in the SEI processing order SEI message is signalled in the SEI processing order SEI message.
      i. In one example, the indication indicates the number of the different SEI payload types minus 1.
         1. Alternatively, the indication indicates the number of the different SEI payload types.
      ii. In one example, the indication corresponds to the syntax element po_num_sei_messages_minus2 in the SEI processing order SEI message.
   b. In one example, alternatively, it is specified that the order of SEI payload types presented in the processing order SEI message indicates the processing order of the SEI messages. That is, an SEI message with a first signalled SEI payload type is processed before another SEI message with a second signalled SEI payload type.
   c. In one example, an indication of the number of different NNPFs for which information is provided in the SEI processing order SEI message is signalled in the SEI processing order SEI message.
      i. In one example, the indication indicates the number of the different NNPFs minus 1.
         1. Alternatively, the indication indicates the number of the different NNPFs.
      ii. In one example, the indication is present for a payload type that indicates the NNPFC SEI message.
         1. Alternatively, the indication is present for a payload type that indicates the NNPFA SEI message.
   d. In one example, an indication of the NNPF identifier (ID) for each of the different NNPFs for which information is provided in the SEI processing order SEI message is signalled in the SEI processing order SEI message.
      i. In one example, when there is only one NNPF for which information is provided in the SEI processing order SEI message, the NNPF ID is not signalled in the SEI processing order SEI message.
   e. Alternatively, furthermore, it is specified that the order of NNPF IDs present in the SEI processing order SEI message indicates the processing order of NNPFs. That is, a NNPF with a first signalled NNPF ID is processed before another NNPF with a second signalled NNPF ID.
2) Alternatively, to solve problem 1, the processing order or preferred processing order of different post-processing filters, including zero or more NNPFs and zero or more non-NNPF post-processing filters, is signalled in the SEI processing order SEI message, and one or more of the following aspects are specified:
   a. In one example, an indication of the number of SEI payload types for which information is provided in the SEI processing order SEI message is signalled in the SEI processing order SEI message.
      i. In one example, the indication indicates the number of the different SEI payload types minus 2.
         1. Alternatively, the indication indicates the number of the different SEI payload types.
   b. In one example, an indication of the NNPF ID of an NNPF for which information is provided in the SEI processing order SEI message is signalled in the SEI processing order SEI message.
      i. In one example, the indication is present for a payload type that indicates the NNPFC SEI message.
         1. Alternatively, the indication is present for a payload type that indicates the NNPFA SEI message.
      ii. In one example, when there is only one NNPF for which information is provided in the SEI processing order SEI message, the NNPF ID is not signalled in the SEI processing order SEI message.
3) For either item 1 or 2 above, in one example, the processing order or preferred processing order of different post-processing filters, including NNPFs and non-NNPF post-processing filters, is signalled in a manner such that the processing order or preferred processing order of any two particular post-processing filters is the same for all pictures within a CLVS.
   a. Alternatively, the processing order or preferred processing order of different post-processing filters, including NNPFs and non-NNPF post-processing filters, is signalled in a manner such that the processing order or preferred processing order of any two particular post-processing filters can be different for different pictures within a CLVS.
   b. Additionally, in one example, an indication (e.g., a flag) may be present in the SEI processing order SEI message which specifies whether the processing order or preferred processing order of any two particular post-processing filters is the same for all pictures within a CLVS.
4) To solve problem 2, in one example, one or more of the following aspects are specified:
   a. In one example, activation of an NNPF and at the same time be associated with an SEI message signalling a non-NNPF post-processing filter, e.g., denoising, film grain, etc., for any picture is disallowed.
   b. In one example, activation of an NNPF with a particular purpose and at the same time be associated with an SEI message signalling a non-NNPF post-processing filter, e.g., denoising, film grain, etc., for any picture is disallowed.
   c. In one example, when an NNPF activated for a picture and at the same time the picture is also associated with an SEI message signalling a non-NNPF post-processing filter, e.g., denoising, film grain, etc., the processing order or preferred processing order is considered as indicated by default to be that the one indicated by the NNPF SEI message is to be processed first.
      i. Alternatively, when an NNPF activated for a picture and at the same time the picture is also associated with an SEI message signalling a non-NNPF post-processing filter, e.g., denoising, film grain, etc., the processing order is considered as indicated by default to be that the one indicated by the non-NNPF SEI message is to be processed first.
5) Alternatively, to solve problem 2, in one example, when an NNPF activated for a picture and at the same time the picture is also associated with an SEI message signalling a non-NNPF post-processing filter, e.g., denoising, film grain, etc., one or more of the following aspects are specified:
   a. In one example, when there are multiple NNPFs activated for a picture and at the same time the picture is also associated with multiple SEI messages signalling non-NNPF post-processing filters, e.g., denoising, film grain, etc., the preferred processing order of the multiple NNPFs and non-NNPF post-processing filters is indicated.
      i. In one example, the preferred processing order of the multiple NNPFs is indicated by the NNPF ID values such that an NNPF with a smaller NNPF ID is processed earlier than another NNPF with a greater NNPF ID, or by another SEI message, or a pre-defined fixed order, or by the NNPF purpose or through other means.
      ii. Alternatively, whether there is a preferred processing order or whether a processing order is preferred or not may be indicated explicitly.
         1. In one example, when the order is indicated in a SEI processing order SEI message, identical po_sei_processing_order[i] values indicate that there is no preferred order of processing. For example, po_sei_processing_order[m] being equal to po_sei_processing_order[n] indicates that there is no preferred order of processing between the types of SEI messages associated with indices m and n.
   b. In one example, when there are multiple NNPFs activated for a picture, referred to as the current picture, and at the same time the picture is also associated with multiple SEI messages signalling non-NNPF post-processing filters, e.g., denoising, film grain, etc., and the processing order of the NNPFs and non-NNPF SEI messages is indicated or derived, the NNPFs or the non-NNPF post-processing filters are applied one by one to the current picture, in the indicated processing order. For the first NNPF or non-NNPF post-processing filter that is applied, the input pictures are cropped decoded pictures. For each of the other NNPFs or non-NNPF post-processing filters that is applied, the input pictures are pictures generated and output by the previously applied NNPF or non-NNPF post-processing filter.
      i. For example, when multiple post-processing filters (e.g., in a chosen post-processing filter group) are applied, they are applied in a cascading manner, meaning that they are applied in the order indicated by the SEI processing order SEI message associated with the chosen post-processing filter group, and for each applied post-processing filter that is not the last-applied post-processing filter, the output is used as the input of the next-applied post-processing filter.
   c. In the above bullets or sub-bullets, cropped decoded picture(s) may be replaced by output picture(s) of an NNPF or a non-NNPF post-processing filter.
6) The payload type indicated in the SEI processing order SEI message may be restricted to a certain set.
   a. In one example, only payload types associated with SEI messages signalling post-processing filters are allowed to be indicated.
   b. In one example, only payload types associated with SEI messages that incur post processing are allowed to be indicated.
   c. For example, a value of po_sei_payload_type[i] for each i in the range of 0 to po_num_sei_messages_minus2+1, inclusive, shall be equal to a payloadType value in the set [3, 4, 5, 19, 137, 142, 144, 147, 148, 149, 165, 177, 210, 211].
7) The indications mentioned above may be signalled using one or more ue(v)-coded syntax elements with a range specified.
   a. In one example, the indication of SEI payload type may be signalled using a ue(v)-coded syntax element with the same range as allowed values for SEI payload type.
   b. In one example, the indication of SEI processing order may be signalled using a ue(v)-coded syntax element.
8) To solve problem 3, in one example, the above examples may be applied by replacing the non-NNPF post-processing filter with other SEI functionalities.

### 6. EMBODIMENTS

Below are some example embodiments for the aspects summarized above in Section 5. Most relevant parts that have been added or modified are enclosed in double braces (i.e., {{a}} indicates that ‘a’ is added), and some of the deleted parts are enclosed in triple brackets (i.e., [[a] indicates that ‘a’ is deleted). There may be some other changes that are editorial in nature and thus not indicated.

### 6.1 Embodiment 1

This embodiment is for items 1, 1.a, 1.a.i, 1.b, 1.b.i, 1.b.ii, 1.c, and 3 as summarized above in Section 5.

### D.11 SEI Processing Order SEI Message

### D.11.1 SEI Processing Order SEI Message Syntax

| | Descriptor |
|---|---|
| sei_processing_order( payloadSize ) { | |
| po_sei_num_payload_types_minus1 | ue(v) |
| [[[for( i = 0, b = 0; b < payloadSize; i++, b += 4 ) { ]]] | |
| {{for( i = 0; i <= po_sei_num_payload_types_minus1; i++ ) { }} | |
| po_sei_payload_type[ i ] | u(16) |
| {{if( po_sei_payload_type[ i ] = = 210 ) { /* 210 indicates the NNPFC SEI message */ | |
| po_sei_num_nnpfs_minus1[ i ] | ue(v) |
| for( j = 0; j <= po_sei_num_nnpfs_minus1[ i ]; j++ ) | |
| po_sei_nnpf_id[ i ][ j ] | ue(v) |
| } | |
| numPostProcessingFilters[ i ] = ( po_sei_payload_type[ i ] = = 210 ) ? | |
| po_sei_num_nnpfs_minus1[ i ] + 1 : 1 | |
| for( j = 0; j < numPostProcessingFilters[ i ]; j++ ) }} | |
| po_sei_processing_order[ i ][ j ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in the bitstream. When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.
It is a requirement of bitstream conformance that, within an SEI processing order SEI message, there shall be at least two [[[pairs]]] {{instances}} of the syntax elements [[[po_sei_payload_type[i] and]]] po_sei_processing_order[i][j], [[[i.e., the syntax elements po_sei_payload_type[0], po_sei_processing_order[0][ ], po_sei_payload_type[1], and po_sei_processing_order[1] shall be present.]]]

{{po_sei_num_payload_types_minus1 plus 1 specifies the number of the po_sei_payload_type[i] syntax elements in the SEI processing order SEI message. The value of po_sei_num_entries_minus1 shall be in the range of 0 to 255, inclusive.}}

po_sei_payload_type[i] specifies the value of payloadType for the i-th SEI message for which information is provided in the SEI processing order SEI message. The values of po_sei_payload_type[m] and po_sei_payload_type[n] shall not be identical when m is not equal to n.

{{po_sei_num_nnpfs_minus1[i] plus 1 specifies the number of NNPFs for which information is provided in the SEI processing order SEI message. The value of po_sei_num_nnpfs_minus1[i] shall be in the range of 0 to 255, inclusive. po_sei_nnpf_id[i][j] indicates the value of the nnpfc_id of the j-th NNPF for which information is provided in the SEI processing order SEI message. The values of po_sei_nnpf_id[i][m] and po_sei_nnpf_id[i][n] shall not be identical when m is not equal to n.}}

]]]po_sei_processing_order[i] indicates the preferred order of processing any SEI message with payloadType equal to po_sei_payload_type[i]. For any two different integer values of m and n that are greater than or equal to 0, po_sei_processing_order[m] less than po_sei_processing_order[n] indicates any SEI message with payloadType equal to po_sei_payload_type[m], when present, should be processed before any SEI message with payloadType equal to po_sei_payload_type[n], when present, and po_sei_processing_order[m] equal to po_sei_processing_order[n] indicates that there is no preferred order of processing between the SEI messages with payloadTypes equal to po_sei_payload_type[m] and po_sei_payload_type[n].]]]

{{po_sei_processing_order[i][j] indicates the preferred order of processing of the post-processing filter signalled by the SEI message with the i-th SEI message type and, when po_sei_payload_type[i] is equal to 210, with nnpfc_id equal to po_sei_nnpf_id[i][j].

For any two different pairs of non-negative integer values {a, b} and {c, d}, po_sei_processing_order[a][b] less than po_sei_processing_order[c][d] indicates that 1) any SEI message with payloadType equal to po_sei_payload_type[a], and, when po_sei_payload_type[a] is equal to 210, with nnpfc_id equal to po_sei_nnpf_id[a][b], when present, should be processed before any SEI message with payloadType equal to po_sei_payload_type[c], and, when po_sei_payload_type[c] is equal to 210, with nnpfc_id equal to po_sei_nnpf_id[c][d], when present, and 2) po_sei_processing_order[a][b] equal to po_sei_processing_order[c][d] indicates that there is no preferred order of processing between any SEI message with payloadType equal to po_sei_payload_type[a], and, when po_sei_payload_type[a] is equal to 210, nnpfc_id equal to po_sei_nnpf_id[a][b], and any SEI message with payloadType equal to po_sei_payload_type[c], and, when po_sei_payload_type[c] is equal to 210, nnpfc_id equal to po_sei_nnpf_id[c][d].}}

### 6.2 Embodiment 2

This embodiment is for items 1, 1.a, 1.a.i, 1.b, 1.b.i, 1.b.ii.1, 1.c, and 3 as summarized above in Section 5. The difference compared to embodiment 1 is the use of po_sei_payload_type[i] equal to 211 (indicating the NNPFA SEI message) instead of 210 (indicating the NNPFC SEI message).

D.11 SEI processing order SEI message

### D.11.1 SEI Processing Order SEI Message Syntax

| | Descriptor |
|---|---|
| sei_processing_order( payloadSize ) { | |
| po_sei_num_payload_types_minus1 | ue(v) |
| [[[for( i = 0, b = 0; b < payloadSize; i++, b += 4 ) { ]]] | |
| {{for( i = 0; i <= po_sei_num_payload_types_minus1; i++ ) { }} | |
| po_sei_payload_type[ i ] | u(16) |
| {{if( po_sei_payload_type[ i ] = = 211 ) { /* 211 indicates the NNPFA SEI message */ | |
| po_sei_num_nnpfs_minus1[ i ] | ue(v) |
| for( j = 0; j <= po_sei_num_nnpfs_minus1[ i ]; j++ ) | |
| po_sei_nnpf_id[ i ][ j ] | ue(v) |
| } | |
| numPostProcessingFilters[ i ] = ( po_sei_payload_type[ i ] = = 211 ) ? | |
| po_sei_num_nnpfs_minus1[ i ] + 1 : 1 | |
| for( j = 0; j < numPostProcessingFilters[ i ]; j++ ) }} | |
| po_sei_processing_order[ i ][ j ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in the bitstream. When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two [[pairs]]] {{instances}} of the syntax elements [[po_sei_payload_type[i] and]]] po_sei_processing_order[i][j], [[i.e., the syntax elements po_sei_payload_type[0], po_sei_processing_order[0][ ], po_sei_payload_type[1], and po_sei_processing_order[1] shall be present.]]] {{po_sei_num_payload_types_minus1 plus 1 specifies the number of the po_sei_payload_type[i] syntax elements in the SEI processing order SEI message. The value of po_sei_num_entries_minus1 shall be in the range of 0 to 255, inclusive.}}

po_sei_payload_type[i] specifies the value of payloadType for the i-th SEI message for which information is provided in the SEI processing order SEI message. The values of po_sei_payload_type[m] and po_sei_payload_type[n] shall not be identical when m is not equal to n.

{{po_sei_num_nnpfs_minus1[i] plus 1 specifies the number of NNPFs for which information is provided in the SEI processing order SEI message. The value of po_sei_num_nnpfs_minus1[i] shall be in the range of 0 to 255, inclusive. po_sei_nnpf_id[i][j] indicates the value of the nnpfa_target_id associated with the j-th NNPF for which information is provided in the SEI processing order SEI message. The values of po_sei_nnpf_id[i][m] and po_sei_nnpf_id[i][n] shall not be identical when m is not equal to n.}}

[[po_sei_processing_order[i] indicates the preferred order of processing any SEI message with payloadType equal to po_sei_payload_type[i]. For any two different integer values of m and n that are greater than or equal to 0, po_sei_processing_order[m] less than po_sei_processing_order[n] indicates any SEI message with payloadType equal to po_sei_payload_type[m], when present, should be processed before any SEI message with payloadType equal to po_sei_payload_type[n], when present, and po_sei_processing_order[m] equal to po_sei_processing_order[n] indicates that there is no preferred order of processing between the SEI messages with payloadTypes equal to po_sei_payload_type[m] and po_sei_payload_type[n].]]]

{{po_sei_processing_order[i][j] indicates the preferred order of processing of the post-processing filter signalled by the SEI message with the i-th SEI message type and, when po_sei_payload_type[i] is equal to 211, with nnpfa_target_id equal to po_sei_nnpf_id[i][j].

For any two different pairs of non-negative integer values {a, b} and {c, d}, po_sei_processing_order[a][b] less than po_sei_processing_order[c][d] indicates that 1) any SEI message with payloadType equal to po_sei_payload_type[a], and, when po_sei_payload_type[a] is equal to 211, with nnpfa_target_id equal to po_sei_nnpf_id[a][b], when present, should be processed before any SEI message with payloadType equal to po_sei_payload_type[c], and, when po_sei_payload_type[c] is equal to 211, with nnpfa_target_id equal to po_sei_nnpf_id[c][d], when and 2) present, po_sei_processing_order[a][b] equal to po_sei_processing_order[c][d] indicates that there is no preferred order of processing between any SEI message with payloadType equal to po_sei_payload_type[a], and, when po_sei_payload_type[a] is equal to 211, with nnpfa_target_id equal to po_sei_nnpf_id[a][b], and any SEI message with payloadType equal to po_sei_payload_type[c], and, when po_sei_payload_type[c] is equal to 211, with nnpfa_target_id equal to po_sei_nnpf_id[c][d].}}

### 6.3 Embodiment 3

This embodiment is for items 2, 2.a, 2.a.i, 2.b, 2.b.i, and 3 as summarized above in Section 5.

### D.11 SEI Processing Order SEI Message

### D.11.1 SEI Processing Order SEI Message Syntax

| | Descriptor |
|---|---|
| sei_processing_order( payloadSize ) { | |
| po_sei_num_entries_minus2 | ue(v) |
| [[[for( i = 0, b = 0; b < payloadSize; i++, b += 4 ) { ]]] | |
| {{ for( i = 0; i < po_sei_num_entries_minus2 + 2; i++ ) { }} | |
| po_sei_payload_type[ i ] | u(16) |
| {{if( po_sei_payload_type[ i ] = = 210 ) /* 210 indicates the NNPFC SEI message */ | |
| po_sei_nnpf_id[ i ] }} | ue(v) |
| po_sei_processing_order[ i ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in the bitstream. When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

[[It is a requirement of bitstream conformance that, within an SEI processing order SEI message, there shall be at least two pairs of the syntax elements po_sei_payload_type[i] and po_sei_processing_order[i], i.e., the syntax elements po_sei_payload_type[0], po_sei_processing_order[0], po_sei_payload_type[1], and po_sei_processing_order[1] shall be present.]]]

{{po_sei_num_entries_minus2 plus 2 specifies the number of the po_sei_payload_type[i] syntax elements in the SEI processing order SEI message. The value of po_sei_num_entries_minus2 shall be in the range of 0 to 254, inclusive.}} po_sei_payload_type[i] specifies the value of payloadType for the i-th SEI message for which information is provided in the SEI processing order SEI message. The values of po_sei_payload_type[m] and po_sei_payload_type[n] shall not be identical when m is not equal to n, {{unless po_sei_payload_type[m] and po_sei_payload_type[n] are both equal to 210.

po_sei_nnpf_id[i] indicates the value of the nnpfc_id of the i-th SEI message, when it is indicated by po_sei_payload_type[i] as an NNPFC SEI message, for which information is provided in the SEI processing order SEI message. The values of po_sei_nnpf_id[m] and po_sei_nnpf_id[n] shall not be identical when m is not equal to n.}}

po_sei_processing_order[i] indicates the preferred order of processing any SEI message with payloadType equal to po_sei_payload_type[i]{{and, when po_sei_payload_type[i] is equal to 210, with nnpfc_id equal to po_sei_nnpf_id[i].}} For any two different integer values of m and n that are greater than or equal to 0, po_sei_processing_order[m] less than po_sei_processing_order[n] indicates {{that 1)}} any SEI message with payloadType equal to po_sei_payload_type[m], {{and, when po_sei_payload_type[m] is equal to 210, with nnpfc_id equal to po_sei_nnpf_id[m],}} when present, should be processed before any SEI message with payloadType equal to po_sei_payload_type[n], {{and, when po_sei_payload_type[n] is equal to 210, with nnpfc_id equal to po_sei_nnpf_id[n],}} when present, and {{2)}} po_sei_processing_order[m] equal to po_sei_processing_order[n] indicates that there is no preferred order of processing between [the SEI messages with payloadTypes]]] {{any SEI message with payloadType}} equal to po_sei_payload_type[m], {{and, when po_sei_payload_type[m] is equal to 210, with nnpfc_id equal to po_sei_nnpf_id[m], and any SEI message with payloadType equal to}} po_sei_payload_type[n], {{and, when po_sei_payload_type[n] is equal to 210, with nnpfc_id equal to po_sei_nnpf_id[n].}}

### 6.4 Embodiment 4

This embodiment is for items 2, 2.a, 2.a.i, 2.b, 2.b.i.1, and 3 as summarized above in Section 5. The difference compared to embodiment 3 is the use of po_sei_payload_type[i] equal to 211 (indicating the NNPFA SEI message) instead of 210 (indicating the NNPFC SEI message).

### D.11 SEI Processing Order SEI Message

### D.11.1 SEI Processing Order SEI Message Syntax

| | Descriptor |
|---|---|
| sei_processing_order( payloadSize ) { | |
| po_sei_num_entries_minus2 | ue(v) |
| [[[for( i = 0, b = 0; b < payloadSize; i++, b += 4 ) { ]]] | |
| {{for( i = 0; i < po_sei_num_entries_minus2 + 2; i++ ) { }} | |
| po_sei_payload_type[ i ] | u(16) |
| {{if( po_sei_payload_type[ i ] = = 211 ) /* 211 indicates the NNPFA SEI message */ | |
| po_sei_nnpf_id[ i ] }} | ue(v) |
| po_sei_processing_order[ i ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in the bitstream. When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

[[It is a requirement of bitstream conformance that, within an SEI processing order SEI message, there shall be at least two pairs of the syntax elements po_sei_payload_type[i] and po_sei_processing_order[i], i.e., the syntax elements po_sei_payload_type[0], po_sei_processing_order[0], po_sei_payload_type[1], and po_sei_processing_order[1] shall be present.]]]

{{po_sei_num_entries_minus2 plus 2 specifies the number of the po_sei_payload_type[i] syntax elements in the SEI processing order SEI message. The value of po_sei_num_entries_minus2 shall be in the range of 0 to 254, inclusive.}} po_sei_payload_type[i] specifies the value of payloadType for the i-th SEI message for which information is provided in the SEI processing order SEI message. The values of po_sei_payload_type[m] and po_sei_payload_type[n] shall not be identical when m is not equal to n, {{unless po_sei_payload_type[m] and po_sei_payload_type[n] are both equal to 211.

po_sei_nnpf_id[i] indicates the value of the nnpfa_target_id of the i-th SEI message, when it is indicated by po_sei_payload_type[i] as an NNPFA SEI message, for which information is provided in the SEI processing order SEI message. The values of po_sei_nnpf_id[m] and po_sei_nnpf_id[n] shall not be identical when m is not equal to n.}}

po_sei_processing_order[i] indicates the preferred order of processing any SEI message with payloadType equal to po_sei_payload_type[i]{{and, when po_sei_payload_type[i] is equal to 211, with nnpfa_target_id equal to po_sei_nnpf_id[i].}} For any two different integer values of m and n that are greater than or equal to 0, po_sei_processing_order[m] less than po_sei_processing_order[n] indicates {{that 1)}} any SEI message with payloadType equal to po_sei_payload_type[m], {{and, when po_sei_payload_type[m] is equal to 211, with nnpfa_target_id equal to po_sei_nnpf_id[m],}} when present, should be processed before any SEI message with payloadType equal to po_sei_payload_type[n], {{and, when po_sei_payload_type[n] is equal to 211, with nnpfa_target_id equal to po_sei_nnpf_id[n],}} when present, and {{2)}} po_sei_processing_order[m] equal to po_sei_processing_order[n] indicates that there is no preferred order of processing between [[[the SEI messages with payloadTypes]]] {{any SEI message with payloadType}} equal to po_sei_payload_type[m], {{and, when po_sei_payload_type[m] is equal to 211, with nnpfa_target_id equal to po_sei_nnpf_id[m], and any SEI message with payloadType equal to}} po_sei_payload_type[n], {{and, when po_sei_payload_type[n] is equal to 211, with nnpfa_target_id equal to po_sei_nnpf_id[n].}}

### 6.5 Embodiment 5

This embodiment covers the items 1, 1.a, 1.a.i, 1.b, 1.b.i, 1.b.ii.1, 1.c, and 3. The difference compared to embodiment 1 is that herein the design is based on the updated SEI processing order SEI message specification in JVET-AC2027 (instead of the SEI processing order SEI message specification in JVET-AB2027).

### D.11 SEI Processing Order SEI Message

### D.11.1 SEI Processing Order SEI Message Syntax

| | Descriptor |
|---|---|
| sei_processing_order( payloadSize ) { | |
| po_sei_num_payload_types_minus1 | ue(v) |
| [[[for( i = 0, b = 0; b < payloadSize; i++, b += 4 ) { ]]] | |
| {{for( i= 0; i <= po_sei_num_payload_types_minus1; i++ ) { }} | |
| po_sei_payload_type[ i ] | u(16) |
| if( po_sei_payload_type[ i ] = = 4 ) { | |
| po_num_t35_byte[ i ] | b(8) |
| [[[b++]]] | |
| for( j = 0; j < po_num_t35_bytes[ i ]; j++ ) | |
| po_t35_byte[ i ][ j ] | b(8) |
| [[[b += po_num_t35_byte[ i ] ]]] | |
| } {{else if( po_sei_payload_type[ i ] = = 210 ) { /* 210: the NNPFC SEI message */ | |
| po_sei_num_nnpfs_minus1[ i ] | ue(v) |
| for( j = 0; j <= po_sei_num_nnpfs_minus1[ i ]; j++ ) | |
| po_sei_nnpf_id[ i ][ j ] | ue(v) |
| } | |
| numPostProcessingFilters[ i ] = ( po_sei_payload_type[ i ] = = 210 ) ? | |
| po_sei_num_nnpfs_minus1[ i ] + 1 : 1 | |
| for( j = 0; j < numPostProcessingFilters[ i ]; j++ ) }} | |
| po_sei_processing_order[ i ][ j ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in a CVS.

When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two [[pairs]]] {{instances}} of the syntax elements [[[po_sei_payload_type[i] and]]] po_sei_processing_order[i]{{[j]}}, and there shall be at least two values of po_sei_processing_order[i]{{[j]}} that are not equal.

{{po_sei_num_payload_types_minus1 plus I specifies the number of the po_sei_payload_type[i] syntax elements in the SEI processing order SEI message. The value of po_sei_num_entries_minus1 shall be in the range of 0 to 255, inclusive.}}

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless they are both equal to 4.

po_num_t35_byte[i], when present, specifies the number of bytes associated with the i-th user data registered by Recommendation ITU-T T.35 SEI message for which preferred processing order information is provided in the SEI processing order SEI message. When not present, the value of po_num_t35_byte[i] is inferred to be equal to 0. po_num_t35_byte[i] equal to 0 indicates that there is no preferred order of processing between user data registered by Recommendation ITU-T T.35 SEI messages.

po_t35_byte[i][j], when present, specifies the j-th byte value of the i-th user data registered by Recommendation ITU-T T.35 SEI message.

{{po_sei_num_nnpfs_minus1[i] plus I specifies the number of NNPFs for which information is provided in the SEI processing order SEI message. The value of po_sei_num_nnpfs_minus1[i] shall be in the range of 0 to 255, inclusive. po_sei_nnpf_id[i][j] indicates the value of the nnpfc_id of the j-th NNPF for which information is provided in the SEI processing order SEI message. The values of po_sei_nnpf_id[i][m] and po_sei_nnpf_id[i][n] shall not be identical when m is not equal to n.}} po_sei_processing_order[i][j] indicates the preferred order of processing of {{the post-processing filter signalled by the SEI message with the i-th SEI message type and, when po_sei_payload_type[i] is equal to 4, with bytes po_t35_byte[n] for n ranging from 0 to po_num_t35_byte[i]−1, inclusive, or when po_sei_payload_type[i] is equal to 210, with nnpfc_id equal to po_sei_nnpf_id[i][j],}} for which preferred processing order information is provided in the SEI processing order SEI message.

[[[For any two different integer values of m and n that are greater than or equal to 0, po_sei_processing_order[m] less than po_sei_processing_order[n] indicates any SEI message type with payloadType equal to po_sei_payload_type[m] and, when present, bytes po_t35_byte[m][p] for p ranging from 0 to po_num_t35_byte[m]−1, inclusive, should be processed before any SEI message type with payloadType equal to po_sei_payload_type[n], and, when present, bytes po_t35_byte[n][q] for q ranging from 0 to po_num_t35_byte[n]−1, inclusive, and po_sei_processing_order[m] equal to po_sei_processing_order[n] indicates that there is no preferred order of processing between the SEI message types.]]]

{{For any two different pairs of non-negative integer values of {a, b} and {c, d}, po_sei_processing_order[a][b] less than po_sei_processing_order[c][d] indicates that 1) any SEI message with payloadType equal to po_sei_payload_type[a] and, when po_sei_payload_type[a] is equal to 4, with bytes po_t35_byte[a][p] for p ranging from 0 to po_num_t35_byte[a]−1, inclusive, or when po_sei_payload_type[a] is equal to 210, with nnpfc_id equal to po_sei_nnpf_id[a][b], should be processed before any SEI message with payloadType equal to po_sei_payload_type[c], and, when po_sei_payload_type[c] is equal to 4, with bytes po_t35_byte[c] [q] for q ranging from 0 to po_num_t35_byte[c]−1, inclusive, or when po_sei_payload_type[c] is equal to 210, with nnpfc_id equal to po_sei_nnpf_id[c][d], and 2)) po_sei_processing_order[a][b] equal to po_sei_processing_order[c][d] indicates that there is no preferred order of processing between the SEI messages.}} When there are multiple user data registered by Recommendation ITU-T T.35 SEI messages with the same content in a CVS, they shall have the same SEI processing order value.

### 6.6 Embodiment 6

This embodiment covers the items 1, 1.a, 1.a.i, 1.b, 1.b.i, 1.b.ii.1, 1.c, and 3. The difference compared to embodiment 5 is the use of po_sei_payload_type[i] equal to 211 (indicating the NNPFA SEI message) instead of 210 (indicating the NNPFC SEI message).

### D.11 SEI Processing Order SEI Message

### D.11.1 SEI Processing Order SEI Message Syntax

| | Descriptor |
|---|---|
| sei_processing_order( payloadSize ) { | |
| po_sei_num_payload_types_minus1 | ue(v) |
| [[[for( i = 0, b = 0; b < payloadSize; i++, b += 4 ) { ]]] | |
| {{for( i = 0; i <= po_sei_num_payload_types_minus1; i++ ) { }} | |
| po_sei_payload_type[ i ] | u(16) |
| if( po_sei_payload_type[ i ] = = 4 ) { | |
| po_num_t35_byte[ i ] | b(8) |
| [[[b++]]] | |
| for( j = 0; j < po_num_t35_bytes[ i ]; j++ ) | |
| po_t35_byte[ i ][ j ] | b(8) |
| [[[b += po_num_t35_byte[ i ] ]]] | |
| } {{else if( po_sei_payload_type[ i ] = = 211 ) { /* 211: the NNPFC SEI message */ | |
| po_sei_num_nnpfs_minus1[ i ] | ue(v) |
| for( j = 0; j <= po_sei_num_nnpfs_minus1[ i ]; j++ ) | |
| po_sei_nnpf_id[ i ][ j ] | ue(v) |
| } | |
| numPostProcessingFilters[ i ] = ( po_sei_payload_type[ i ] = = 211 ) ? | |
| po_sei_num_nnpfs_minus1[ i ] + 1 : 1 | |
| for( j = 0; j < numPostProcessingFilters[ i ]; j++ ) }} | |
| po_sei_processing_order[ i ][ j ] | u(16) |
| } | |
| } | |

### D.11.2 SEI Processing Order SEI Message Semantics

The SEI processing order SEI message carries information indicating the preferred processing order, as determined by the encoder (i.e., the content producer), for different types of SEI messages that may be present in a CVS.

When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least the two [[pairs]]] {{instances}} of syntax elements [[po_sei_payload_type[i] and]]] po_sei_processing_order[i]{{[j]}}, and there shall be at least two values of po_sei_processing_order[i]{{[j]}} that are not equal.

{{po_sei_num_payload_types_minus1 plus 1 specifies the number of the po_sei_payload_type[i] syntax elements in the SEI processing order SEI message. The value of po_sei_num_entries_minus1 shall be in the range of 0 to 255, inclusive.}}

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless they are both equal to 4.

po_num_t35_byte[i], when present, specifies the number of bytes associated with the i-th user data registered by Recommendation ITU-T T.35 SEI message for which preferred processing order information is provided in the SEI processing order SEI message. When not present, the value of po_num_t35_byte[i] is inferred to be equal to 0. po_num_t35_byte[i] equal to 0 indicates that there is no preferred order of processing between user data registered by Recommendation ITU-T T.35 SEI messages.

po_t35_byte[i][j], when present, specifies the j-th byte value of the i-th user data registered by Recommendation ITU-T T.35 SEI message.

{{po_sei_num_nnpfs_minus1[i] plus 1 specifies the number of NNPFs for which information is provided in the SEI processing order SEI message. The value of po_sei_num_nnpfs_minus1[i] shall be in the range of 0 to 255, inclusive. po_sei_nnpf_id[i][j] indicates the value of the nnpfc_id of the j-th NNPF for which information is provided in the SEI processing order SEI message. The values of po_sei_nnpf_id[i][m] and po_sei_nnpf_id[i][n] shall not be identical when m is not equal to n.}}

po_sei_processing_order[i][j] indicates the preferred order of processing of {{the post-processing filter signalled by the SEI message with the i-th SEI message type and, when po_sei_payload_type[i] is equal to 4, with bytes po_t35_byte[n] for n ranging from 0 to po_num_t35_byte[i]−1, inclusive, or when po_sei_payload_type[i] is equal to 211, with nnpfa_target_id equal to po_sei_nnpf_id[i][j],}} for which preferred processing order information is provided in the SEI processing order SEI message.

[[[For any two different integer values of m and n that are greater than or equal to 0, po_sei_processing_order[m] less than po_sei_processing_order[n] indicates any SEI message type with payloadType equal to po_sei_payload_type[m] and, when present, bytes po_t35_byte[m][p] for p ranging from 0 to po_num_t35_byte[m]−1, inclusive, should be processed before any SEI message type with payloadType equal to po_sei_payload_type[n], and, when present, bytes po_t35_byte[n][q] for q ranging from 0 to po_num_t35_byte[n]−1, inclusive, and po_sei_processing_order[m] equal to po_sei_processing_order[n] indicates that there is no preferred order of processing between the SEI message types.]]]

{{For any two different pairs of non-negative integer values of {a, b} and {c, d}, po_sei_processing_order[a][b] less than po_sei_processing_order[c][d] indicates that 1) any SEI message with payloadType equal to po_sei_payload_type[a] and, when po_sei_payload_type[a] is equal to 4, with bytes po_t35_byte[a][p] for p ranging from 0 to po_num_t35_byte[a]−1, inclusive, or when po_sei_payload_type[a] is equal to 211, with nnpfa_target_id equal to po_sei_nnpf_id[a][b], should be processed before any SEI message with payloadType equal to po_sei_payload_type[c], and, when po_sei_payload_type[c] is equal to 4, with bytes po_t35_byte[c] [q] for q ranging from 0 to po_num_t35_byte[c]−1, inclusive, or when po_sei_payload_type[c] is equal to 211, with nnpfa_target_id equal to po_sei_nnpf_id[c][d], and 2) po_sei_processing_order[a][b] equal to po_sei_processing_order[c][d] indicates that there is no preferred order of processing between the SEI messages.}} When there are multiple user data registered by Recommendation ITU-T T.35 SEI messages with the same content in a CVS, they shall have the same SEI processing order value.

### 7. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2022.
[4] Rec. ITU-T Rec. H.274|ISO/IEC 23002-7, “Versatile Supplemental Enhancement Information Messages for Coded Video Bitstreams”, 2022.
[5] S. McCarthy, S. Deshpande, M. Hannuksela, Hendry, G. Sullivan, and Y.-K. Wang (editors), “Improvements under consideration for neural network post filter SEI messages,” JVET output document JVET-AC2032, publicly available online herein: https://jvet-experts.org/doc_end_user/current_document.php?id=12585.
[6] E. Francois, B. Bross, M. M. Hannuksela, A. M. Tourapis, and Y.-K. Wang (editors), “New level and systems-related supplemental enhancement information for VVC (Draft 4)”, JVET output document JVET-AC2005, publicly available online herein: https://www.jvet-experts.org/doc_end_user/current_document.php?id=12574.
[7] S. McCarthy, M. M. Hannuksela, and Y.-K. Wang (editors), “SEI processing order SEI message in VVC (draft 2) “, JVET output JVET-AB2027, publicly available online herein: https://www.jvet-experts.org/doc_end_user/current_document.php?id=12223.
[8] S. McCarthy, M. M. Hannuksela, and Y.-K. Wang (editors), “SEI processing order SEI message in VVC (draft 3), JVET document JVET-AC2027, publicly available online herein: https://www.jvet-experts.org/doc_end_user/current_document.php?id=12582.

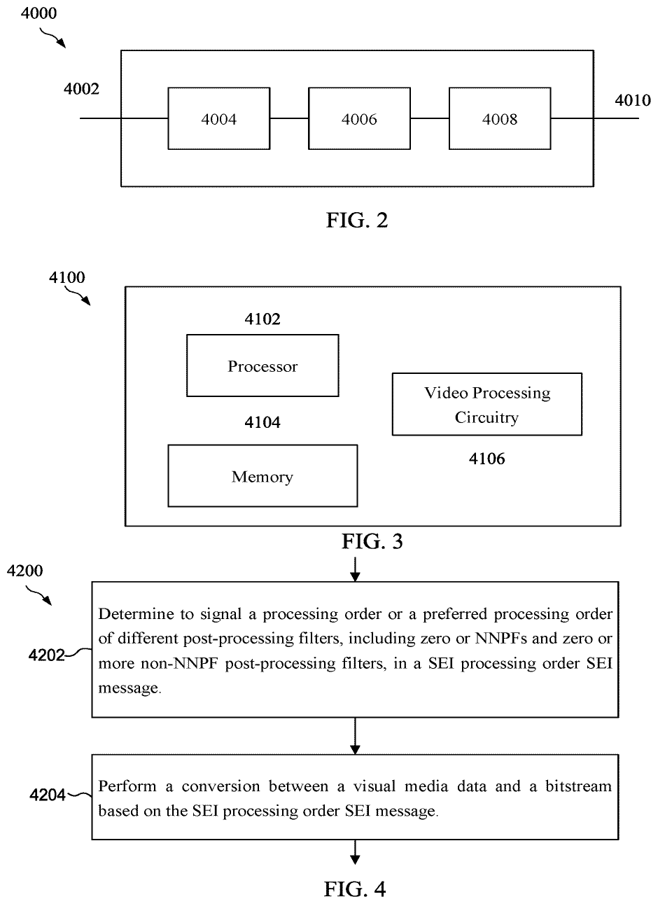

FIG. 2 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 4 is a flowchart for an example method 4200 of video processing. The method 4200 determines to signal a processing order or a preferred processing order of different post-processing filters, including zero or more neural-network post-filters (NNPFs) and zero or more non-NNPF post-processing filters, in a supplemental enhancement information (SEI) processing order SEI message at step 4202. A conversion is performed between a visual media data and a bitstream based on the SEI processing order SEI message at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

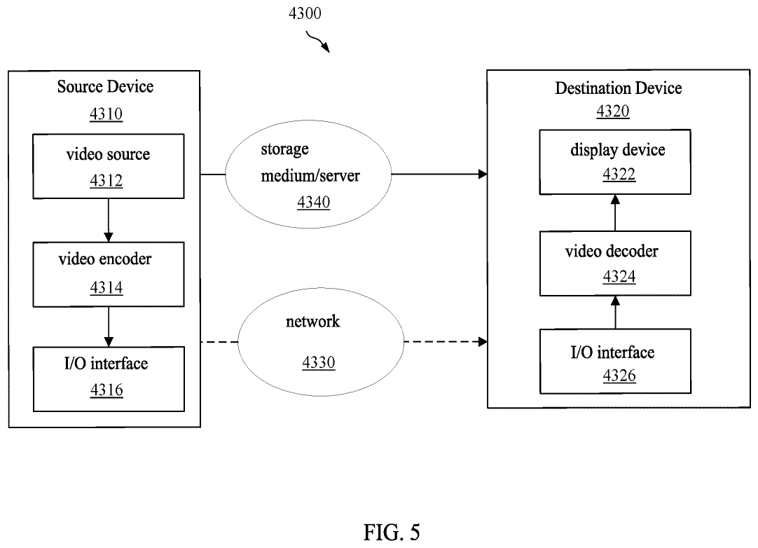

FIG. 5 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O) interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the HEVC standard, the VVC standard, and other current and/or further standards.

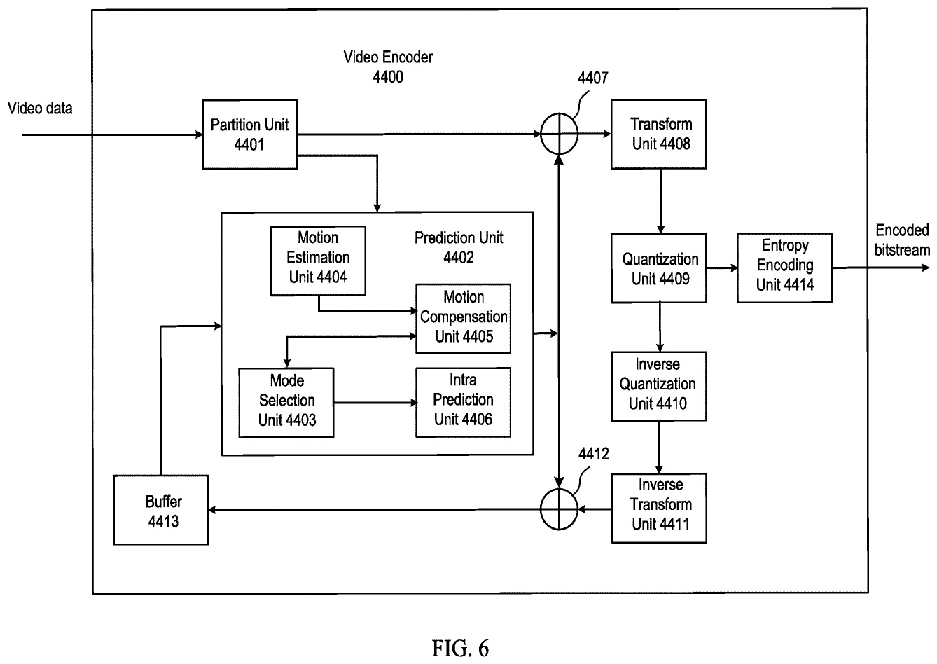

FIG. 6 is a block diagram illustrating an example of video encoder 4400, which may be video encoder 4314 in the system 4300 illustrated in FIG. 5. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

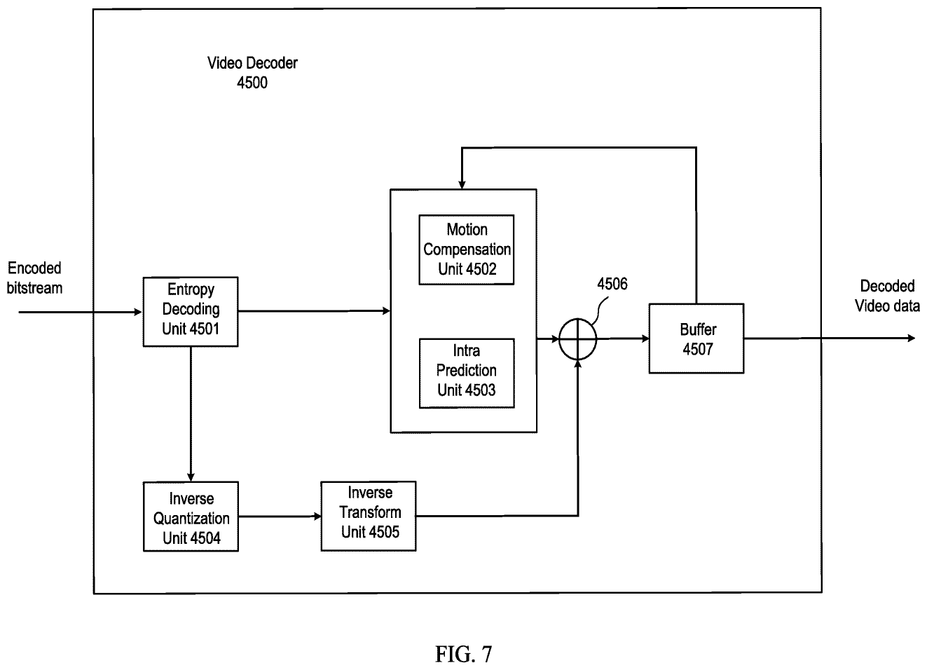

FIG. 7 is a block diagram illustrating an example of video decoder 4500 which may be video decoder 4324 in the system 4300 illustrated in FIG. 5. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

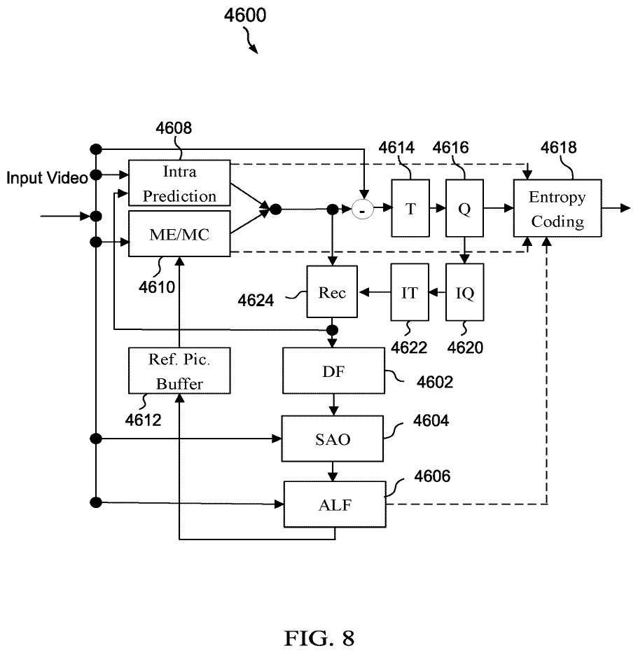

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing media data comprising: determining to signal a processing order or a preferred processing order of different post-processing filters, including zero or more neural-network post-filters (NNPFs) and zero or more non-NNPF post-processing filters, in a supplemental enhancement information (SEI) processing order SEI message; and performing a conversion between a visual media data and a bitstream based on the SEI processing order SEI message.

2. The method of solution 1, wherein an indication of a number of different SEI payload types for which information is provided in the SEI processing order SEI message is signalled in the SEI processing order SEI message.

3. The method of any of solutions 1-2, wherein the indication indicates the number of the different SEI payload types or the number of the different SEI payload types minus 1.

4. The method of any of solutions 1-3, wherein an order of SEI payload types presented in the processing order SEI message indicates the processing order of the SEI messages, and wherein an SEI message with a first signalled SEI payload type is processed before another SEI message with a second signalled SEI payload type.

5. The method of any of solutions 1-4, wherein an indication of a number of different NNPFs for which information is provided in the SEI processing order SEI message is signalled in the SEI processing order SEI message.

6. The method of any of solutions 1-5, wherein the indication indicates the number of the different NNPFs or the number of the different NNPFs minus 1, and wherein the indication is present for a payload type that indicates a neural-network post-filter characteristics (NNPFC) SEI message or the indication is present for a payload type that indicates a neural-network post-filter activation (NNPFA) SEI message.

7. The method of any of solutions 1-6, wherein an indication of an NNPF identifier (ID) for each of the different NNPFs for which information is provided in the SEI processing order SEI message is signalled in the SEI processing order SEI message, or wherein when there is only one NNPF for which information is provided in the SEI processing order SEI message, the NNPF ID is not signalled in the SEI processing order SEI message.

8. The method of any of solutions 1-7, wherein an order of NNPF IDs present in the SEI processing order SEI message indicates the processing order of NNPFs, and wherein a first signalled NNPF ID is processed before another NNPF with a second signalled NNPF ID.

9. The method of any of solutions 1-8, wherein an indication of the NNPF ID of an NNPF for which information is provided in the SEI processing order SEI message is signalled in the SEI processing order SEI message, wherein the indication is present for a payload type that indicates a NNPFC SEI message or a NNPFA SEI message, or wherein when there is only one NNPF for which information is provided in the SEI processing order SEI message, the NNPF ID is not signalled in the SEI processing order SEI message.

10. The method of any of solutions 1-9, wherein the processing order or preferred processing order of different post-processing filters, including NNPFs and non-NNPF post-processing filters, is signalled such that the processing order or preferred processing order of any two particular post-processing filters is the same for all pictures within a coded layer video sequence (CLVS).

11. The method of any of solutions 1-10, wherein the processing order or preferred processing order of different post-processing filters, including NNPFs and non-NNPF post-processing filters, is signalled such that the processing order or preferred processing order of any two particular post-processing filters can be different for different pictures within a CLVS.

12. The method of any of solutions 1-11, wherein an indication is present in the SEI processing order SEI message which specifies whether the processing order or preferred processing order of any two particular post-processing filters is the same for all pictures within a CLVS.

13. The method of any of solutions 1-12, wherein one or more of the following is specified: activation of an NNPF for a picture and simultaneous association of the picture with an SEI message indicating a non-NNPF post-processing filter is disallowed, activation of an NNPF with a particular purpose for a picture and simultaneous association of the picture with an SEI message indicating a non-NNPF post-processing filter is disallowed when an NNPF is activated for a picture and at the same time the picture is also associated with an SEI message signalling a non-NNPF post-processing filter, the processing order or preferred processing order is considered as indicated by default to be that the one indicated by the NNPF SEI message is to be processed first, or when an NNPF is activated for a picture and at the same time the picture is also associated with an SEI message signalling a non-NNPF post-processing filter, the processing order is considered as indicated by default to be that the one indicated by the non-NNPF SEI message is to be processed first.

14. The method of any of solutions 1-13, wherein when an NNPF is activated for a picture and at the same time the picture is also associated with an SEI message signalling a non-NNPF post-processing filter, one or more of the following aspects are specified: when there are multiple NNPFs activated for a picture and at the same time the picture is also associated with multiple SEI messages signalling non-NNPF post-processing filters the preferred processing order of the multiple NNPFs and non-NNPF post-processing filters is indicated, the preferred processing order of the multiple NNPFs is indicated by the NNPF ID values such that an NNPF with a smaller NNPF ID is processed earlier than another NNPF with a greater NNPF ID, by another SEI message, a pre-defined fixed order, by the NNPF purpose, or combinations thereof, whether there is a preferred processing order or whether a processing order is preferred or not may be indicated explicitly, when the order is indicated in a SEI processing order SEI message, identical po_sei_processing_order[i] values indicate that there is no preferred order of processing, when there are multiple NNPFs activated for a picture, referred to as the current picture, at the same time the current picture is also associated with multiple SEI messages signalling non-NNPF post-processing filters, and the processing order of the NNPFs and non-NNPF SEI messages is indicated or derived, the NNPFs or the non-NNPF post-processing filters are applied one by one to the current picture in the indicated processing order, for a first NNPF or non-NNPF post-processing filter that is applied, input pictures are cropped decoded pictures, for each of the other NNPFs or non-NNPF post-processing filters that is applied, the input pictures are pictures generated and output by a previously applied NNPF or non-NNPF post-processing filter, or when there are multiple NNPFs activated for a picture, referred to as the current picture, at the same time the current picture is also associated with multiple SEI messages signalling non-NNPF post-processing filters, and the processing order of the NNPFs and non-NNPF SEI messages is indicated or derived, the NNPFs or the non-NNPF post-processing filters are applied one by one to the current picture in the indicated processing order, for a first NNPF or non-NNPF post-processing filter that is applied, input pictures are output pictures, for each of the other NNPFs or non-NNPF post-processing filters that is applied, the input pictures are pictures generated and output by a previously applied NNPF or non-NNPF post-processing filter.

15. The method of any of solutions 1-14, wherein the payload type indicated in the SEI processing order SEI message is restricted to a certain set, wherein only payload types associated with SEI messages signalling post-processing filters are allowed to be indicated, or wherein only payload types associated with SEI messages that incur post processing are allowed to be indicated.

16. The method of any of solutions 1-15, wherein the indication of SEI payload type is signalled using a ue(v)-coded syntax element with the same range as allowed values for SEI payload type, or wherein the indication of SEI processing order is signalled using a ue(v)-coded syntax element.

17. An apparatus for processing video data comprising: a processor; and a non-transitory memory with instructions thereon, wherein the instructions upon execution by the processor, cause the processor to perform the method of any of solutions 1-16.

18. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-17.

19. A non-transitory computer-readable recording medium storing a bitstream of a video which is generated by a method performed by a video processing apparatus, wherein the method comprises: determining to signal a processing order or a preferred processing order of different post-processing filters, including zero or more neural-network post-filters (NNPFs) and zero or more non-NNPF post-processing filters, in a supplemental enhancement information (SEI) processing order SEI message; and generating a bitstream based on the determining.

20. A method for storing bitstream of a video comprising: determining to signal a processing order or a preferred processing order of different post-processing filters, including zero or more neural-network post-filters (NNPFs) and zero or more non-NNPF post-processing filters, in a supplemental enhancement information (SEI) processing order SEI message; generating a bitstream based on the determining; and storing the bitstream in a non-transitory computer-readable recording medium.

21. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding. video decoding. video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining whether a processing order or a preferred processing order of different post-processing filters (PPFs), including zero or more neural-network post-filters (NNPFs) and zero or more non-NNPF post-processing filters, is present in a supplemental enhancement information (SEI) processing order SEI message; and
performing a conversion between a visual media data and a bitstream based on the SEI processing order SEI message.

2. The method of claim 1, wherein a first indication that relates to a number of types of SEI messages for which the preferred processing order is indicated in the SEI processing order SEI message, is present in the SEI processing order SEI message.

3. The method of claim 2, wherein the first indication indicates the number of the types of SEI messages minus 2.

4. The method of claim 2, wherein the first indication corresponds to a syntax element po_num_sei_messages_minus2 in the SEI processing order SEI message.

5. The method of claim 1, wherein when there are multiple NNPFs activated for a picture and at the same time the picture is also associated with multiple SEI messages signalling non-NNPF post-processing filters, whether there is a preferred processing order of the multiple NNPFs and non-NNPF post-processing filters, or whether a processing order of the multiple NNPFs and non-NNPF post-processing filters is preferred, is indicated explicitly.

6. The method of claim 1, wherein a second indication po_sei_processing_order[i] is present in the SEI processing order SEI message, wherein po_sei_processing_order[i] indicates a preferred order information of processing of an i-th type of SEI message, wherein i is an integer.

7. The method of claim 6, wherein po_sei_processing_order[m] being equal to po_sei_processing_order[n] indicates that there is no preferred order of processing between the types of SEI messages associated with indices m and n, wherein m and n are integers and m is different from n.

8. The method of claim 1, wherein when there are multiple NNPFs activated for a current picture and, at the same time, the current picture is also associated with multiple SEI messages signalling non-NNPF post-processing filters, NNPF or non-NNPF PPFs are applied in an order indicated in the SEI processing order SEI message.

9. The method of claim 8, wherein for each applied PPF that is not a last applied PPF, output of a current PPF is used as input of a next applied PPF.

10. The method of claim 1, wherein a payload type is indicated in the SEI processing order SEI message, and the payload type is restricted to a certain set.

11. The method of claim 1, wherein a payload type is indicated in the SEI processing order SEI message, and a value of the payload is restricted to a set [3, 4, 5, 19, 137, 142, 144, 147, 148, 149, 165, 177, 210, 211].

12. The method of claim 1, wherein the conversion includes encoding the visual media data into the bitstream.

13. The method of claim 1, wherein the conversion includes decoding the visual media data from the bitstream.

14. An apparatus for processing media data, comprising: a processor; and a non-transitory memory with instructions thereon, wherein the instructions upon execution by the processor, cause the processor to:
determine whether a processing order or a preferred processing order of different post-processing filters (PPFs), including zero or more neural-network post-filters (NNPFs) and zero or more non-NNPF post-processing filters, is present in a supplemental enhancement information (SEI) processing order SEI message; and
perform a conversion between a visual media data and a bitstream based on the SEI processing order SEI message.

15. The apparatus of claim 14, wherein a first indication that relates to a number of types of SEI messages for which the preferred processing order is indicated in the SEI processing order SEI message, is present in the SEI processing order SEI message, wherein the first indication indicates the number of the types of SEI messages minus 2, and wherein the first indication corresponds to a syntax element po_num_sei_messages_minus2 in the SEI processing order SEI message, and
wherein when there are multiple NNPFs activated for a picture and at the same time the picture is also associated with multiple SEI messages signalling non-NNPF post-processing filters, whether there is a preferred processing order of the multiple NNPFs and non-NNPF post-processing filters, or whether a processing order of the multiple NNPFs and non-NNPF post-processing filters is preferred is indicated explicitly, and
wherein a second indication po_sei_processing_order[i] is present in the SEI processing order SEI message, wherein po_sei_processing_order[i] indicates a preferred order information of processing of an i-th type of SEI message, wherein i is an integer, and wherein po_sei_processing_order[m] being equal to po_sei_processing_order[n] indicates that there is no preferred order of processing between the types of SEI messages associated with indices m and n, wherein m and n are integers and m is different from n.

16. The apparatus of claim 14, wherein when there are multiple NNPFs activated for a current picture and at the same time the current picture is also associated with multiple SEI messages signalling non-NNPF post-processing filters, NNPF or non-NNPF PPFs are applied in an order indicated in the SEI processing order SEI message,
wherein for each applied PPF that is not a last applied PPF, output of a current PPF is used as input of a next applied PPF,
wherein a payload type is indicated in the SEI processing order SEI message, and the payload type is restricted to a certain set, and
wherein a payload type is indicated in the SEI processing order SEI message, and a value of the payload is restricted to a set [3, 4, 5, 19, 137, 142, 144, 147, 148, 149, 165, 177, 210, 211].

17. A non-transitory computer readable storage medium storing instructions that cause a processor to:
determine whether a processing order or a preferred processing order of different post-processing filters (PPFs), including zero or more neural-network post-filters (NNPFs) and zero or more non-NNPF post-processing filters, is present in a supplemental enhancement information (SEI) processing order SEI message; and
perform a conversion between a visual media data and a bitstream based on the SEI processing order SEI message.

18. The non-transitory computer readable medium of claim 17, wherein a first indication that relates to a number of types of SEI messages for which the preferred processing order is indicated in the SEI processing order SEI message, is present in the SEI processing order SEI message, wherein the first indication indicates the number of the types of SEI messages minus 2, and wherein the first indication corresponds to a syntax element po_num_sei_messages_minus2 in the SEI processing order SEI message,
wherein when there are multiple NNPFs activated for a picture and at the same time the picture is also associated with multiple SEI messages signalling non-NNPF post-processing filters, whether there is a preferred processing order of the multiple NNPFs and non-NNPF post-processing filters, or whether a processing order of the multiple NNPFs and non-NNPF post-processing filters is preferred is indicated explicitly,
wherein a second indication po_sei_processing_order[i] is present in the SEI processing order SEI message, wherein po_sei_processing_order[i] indicates a preferred order information of processing of an i-th type of SEI message, wherein i is an integer, and wherein po_sei_processing_order[m] being equal to po_sei_processing_order[n] indicates that there is no preferred order of processing between the types of SEI messages associated with indices m and n, wherein m and n are integers and m is different from n,
wherein when there are multiple NNPFs activated for a current picture and at the same time the current picture is also associated with multiple SEI messages signalling non-NNPF post-processing filters, NNPF or non-NNPF PPFs are applied in an order indicated in the SEI processing order SEI message,
wherein for each applied PPF that is not a last applied PPF, output of a current PPF is used as input of a next applied PPF,
wherein a payload type is indicated in the SEI processing order SEI message, and the payload type is restricted to a certain set, and
wherein a payload type is indicated in the SEI processing order SEI message, and a value of the payload is restricted to a set [3, 4, 5, 19, 137, 142, 144, 147, 148, 149, 165, 177, 210, 211].

19. A non-transitory computer-readable recording medium storing a bitstream of a video which is generated by a method performed by a video processing apparatus, wherein the method comprises:
determining whether a processing order or a preferred processing order of different post-processing filters (PPFs), including zero or more neural-network post-filters (NNPFs) and zero or more non-NNPF post-processing filters, is present in a supplemental enhancement information (SEI) processing order SEI message; and
generating a bitstream based on the SEI processing order SEI message.

20. The non-transitory computer-readable recording medium of claim 19, wherein a first indication that relates to a number of types of SEI messages for which the preferred processing order is indicated in the SEI processing order SEI message, is present in the SEI processing order SEI message, wherein the first indication indicates the number of the types of SEI messages minus 2, and wherein the first indication corresponds to a syntax element po_num_sei_messages_minus2 in the SEI processing order SEI message,
wherein when there are multiple NNPFs activated for a picture and at the same time the picture is also associated with multiple SEI messages signalling non-NNPF post-processing filters, whether there is a preferred processing order of the multiple NNPFs and non-NNPF post-processing filters, or whether a processing order of the multiple NNPFs and non-NNPF post-processing filters is preferred is indicated explicitly,
wherein a second indication po_sei_processing_order[i] is present in the SEI processing order SEI message, wherein po_sei_processing_order[i] indicates a preferred order information of processing of an i-th type of SEI message, wherein i is an integer, and wherein po_sei_processing_order[m] being equal to po_sei_processing_order[n] indicates that there is no preferred order of processing between the types of SEI messages associated with indices m and n, wherein m and n are integers and m is different from n,
wherein when there are multiple NNPFs activated for a current picture and at the same time the current picture is also associated with multiple SEI messages signalling non-NNPF post-processing filters, NNPF or non-NNPF PPFs are applied in an order indicated in the SEI processing order SEI message,
wherein for each applied PPF that is not a last applied PPF, output of a current PPF is used as input of a next applied PPF,
wherein a payload type is indicated in the SEI processing order SEI message, and the payload type is restricted to a certain set, and
wherein a payload type is indicated in the SEI processing order SEI message, and a value of the payload is restricted to a set [3, 4, 5, 19, 137, 142, 144, 147, 148, 149, 165, 177, 210, 211].
